(19) United States
(12) Patent Application Publication
(10) Pub. No.: US 2014/0310643 A1
(43) Pub. Date: Oct. 16, 2014

(54) MOBILE DEVICE WITH USER INTERFACE

(71) Applicants: Sergey Karmanenko, St. Petersburg (RU); Igor Mikhnenko, Kharkov (UA); Vera Kozyr, St. Petersburg (RU); Dmitry Alekseevich Gorilovsky, St. Petersburg (RU)

(72) Inventors: Sergey Karmanenko, St. Petersburg (RU); Igor Mikhnenko, Kharkov (UA); Vera Kozyr, St. Petersburg (RU); Dmitry Alekseevich Gorilovsky, St. Petersburg (RU)

(73) Assignee: YOTA DEVICES IPR LTD., Tortola (VG)

(21) Appl. No.: 13/992,826

(22) PCT Filed: Dec. 12, 2011
(86) PCT No.: PCT/RU2011/000979

§ 371 Date: Feb. 10, 2014

(30) Foreign Application Priority Data
Dec. 10, 2010 (GB) 1020999.7
Jan. 21, 2011 (GB) 1101078.2
Jul. 20, 2011 (GB) 1112458.3
Oct. 3, 2011 (GB) 1117000.8

(51) Int. Cl. H04M 1/02; G06F 3/0488; G06F 3/0485

(52) U.S. Cl. CPC H04M 1/0202; G06F 3/0485; G06F 3/0488
USPC 715/784; 455/566

(57) ABSTRACT

There is provided a bar form factor mobile display device comprising front and back major faces, the front major face arranged to present a normal power first display screen and the back major face arranged to present a low power second display screen, wherein the device includes a computer.

### BACKGROUND OF THE INVENTION

1. Field of the Invention

The field of the invention relates to mobile display devices comprising a first display screen and a second display screen, to user interface aspects of such devices, to methods of operating such devices, and to computer program products operable to run on such devices.

2. Technical Background

Bar form factor display devices, eg. slate devices such as the iPhone™ and the iPad™, are known. However, these devices comprise only a single display screen. A bar form factor device may be a slate device.

3. Discussion of Related Art

In US2008002115A1, as shown in prior art FIG. 66, there is disclosed a display stack-up 300 which is provided for a mobile electronic device 100 having an internal and external display, for example a clamshell style mobile phone. The display stack-up comprises a backlight unit 114 and an external display device 110 having bi-stable optical states. The external display device 110 is placed in contact with, and is optically coupled to, the backlight unit 114. The display stack-up further comprises an internal display device 106 which is placed in contact with, and is optically coupled to, the external display device 110.

The terms “internal display” and “external display” employed in US2008002115A1 arise because the device disclosed therein contains a hinged part such that one display is permanently visible to a user (the “external display”), while the other display may or may not be visible to a user (the “internal display”). Prior art FIG. 67 is disclosed in US2008002115A1. In US2008002115A1 it is disclosed that the mobile electronic device 100 includes a first housing member 102 and a second housing member 104.

The first housing member 102 and the second housing member 104 may be made up of materials like metal, plastic, glass and/or hybrids thereof. The first housing member 102 and the second housing member 104 are hingedly connected with one another and are configurable in the open and closed positions. In other words, the first housing member 102 and the second housing member 104 are connected to each other with a hinge such that the angle between the two is approximately 180° or less, when configured in an open position, and the minimum angle is approximately 0° or slightly greater, when configured in the closed position. The first housing member 102 further comprises an external display aperture 101 and an internal display aperture 103 through which the external display device 110 and internal display device 106 are viewable, respectively. The display itself comprises three primary devices which are encased by the first housing member 102. In the cross sectional view of prior art FIG. 67, the three devices are shown in a “stack-up” configuration having the internal display device 106, the external display device 110, and a backlight device 108.

Prior art FIG. 68 taken from US2008002115A1 shows the hinged mobile phone disclosed therein in the closed configuration. In the closed configuration the inner display surface is protected from scratching which may occur eg. when the device is inside a woman's handbag and it comes into contact with various items such as keys, make up casing and metal elements on the surface of a money holder. The closed configuration is more compact than the open configuration of prior art FIG. 67; the compactness is useful when the device is being transported, eg. in a woman's handbag, because its greatest lateral extent is reduced with respect to the open configuration. The interface components are kept inside the hinged phone, which offers more surface area when the device is open than when the device is closed. Interface components such as keypad keys and an internal display are protected when the device is closed, and when closed it is less long or wide, making the device easier to carry around. When a hinged phone is in the closed configuration, the second display can be used for display purposes because the first display may not be visible in the closed configuration.

The device of prior art FIGS. 67 and 68 is not a bar form factor device because it consists of two parts connected by a hinge.

### SUMMARY OF THE INVENTION

According to a first aspect of the invention, there is provided a bar form factor mobile display device comprising front and back major faces, the front major face arranged to present a normal power first display screen and the back major face arranged to present a low power second display screen, wherein the device includes a computer.

The bar form factor mobile display device may be one wherein the second display screen is a Grayscale panel.

The bar form factor mobile display device may be one wherein the second display screen is a bi-stable display screen.

The bar form factor mobile display device may be one wherein the bi-stable display screen is a bi-stable active matrix and high-resolution display screen.

The bar form factor mobile display device may be one wherein the bi-stable display screen is an E-ink bi-stable display screen.

The bar form factor mobile display device may be one wherein the second display screen is an Electronic Paper Display.

The bar form factor mobile display device may be one wherein the device includes sensors and wherein the device is operable to process input from the sensors when the first display screen is off.

The device may be operable to process input from sensors in the device when the first display screen is off, in response to a specific event.

The device may be one wherein the specific event is a notification being displayed on the second display screen.

The device may be one wherein one or more sensors are operable to sense which screen a user is interacting with.

The device may include pressure sensors on opposed sides of the device operable to receive pressure input from a user.

The device may include volume buttons on the device operable to receive input from a user.

The device may include an accelerometer sensor and a gyroscope sensor.

The device may be one wherein the first display screen is a touch screen.

The device may be one wherein the first display is operable to receive multi touch input.

The device may be one wherein the second display screen is a touch screen.

The device may be one wherein the second display is operable to receive multi touch input.

The device may be one wherein the computer is programmed with an Android operating system.

The device may be one wherein the device operates as a one screen device in the Android operating system.

The device may be one wherein the first display screen output is generated by a first application and the second display screen output is generated by a second application different to the first application.

The device may be one wherein the first display is operable to display a home screen pane corresponding to the second display screen.

The device may be one wherein the second application is operable to communicate with specified applications.

The device may be one wherein only specified applications are allowed to communicate with the second application.

The device may be one wherein the second display is operable to display a plurality of widgets, wherein at least two of the widgets have different update frequencies.

The device may be one wherein the update of at least two widgets are synchronized, wherein synchronization provides for energy saving in device power usage.

The device may be one wherein the update of all widgets are synchronized, wherein synchronization provides for energy saving in device power usage.

The device may be one wherein the update is a screen update of the second screen.

The device may be further operable to operate in a mode in which the screen update of widgets on the second screen is not synchronized.

The device may be further operable to perform a full screen refresh of the second screen.

The device may be one wherein the second display is operable to be configured.

The device may be one wherein the second display configuration is operable to be changed via the first display.

The device may be one wherein a device screen page for initiating the changing of the configuration of the second display is at the same level in the menu hierarchy as other home panes on the device.

The device may be one wherein the device screen page for initiating the changing of the second display configuration is accessible by swiping through other screens.

The device may be one wherein the device screen page for initiating the changing of the second display configuration is accessible by a screen wide two finger swipe.

The device may be one wherein a two finger swipe in a first direction brings up the screen page for initiating the changing of the second display configuration, and a two finger swipe in the opposite direction to the first direction brings up a previously displayed home page.

The device may be one wherein the first display is operable to display a plurality of home panes, wherein a shortcut icon is displayed on each home pane.

The device may be one wherein when the shortcut icon is selected by a user, the icon is expanded to provide a shortcut to each home pane.

The device may be one wherein the expanded icon which provides a short cut to each home page is operable to provide a preview of a home screen in response to a finger touch on the corresponding home screen short cut.

The device may be one wherein the device is operable to display a home screen in response to the release of a finger from the corresponding home screen short cut.

The device may be one wherein the second display displays only wallpaper when a user is interacting with the first display.

The device may be one wherein the wallpaper is Android live wallpaper.

The device may be one wherein the second display configuration screen displayed on the first display includes a replica of the second display screen.

The device may be one wherein a part of the second display screen is not operable to display widgets.

The device may be one wherein the replica excludes parts of the second display screen which are not operable to display widgets.

The device may be one wherein the second display configuration screen is configurable to display a portion of an options menu.

The device may be one wherein when the portion of an options menu is displayed, the portion of the options menu includes an on/off switch for widgets.

The device may be one wherein the portion of the options menu is operable to be folded in response to a user tapping on the screen outside the displayed portion of the options menu.

The device may be one wherein the displayed portion of the options menu provides a selectable option which provides options for adding widgets, configuring the second screen wallpaper and for altering the second screen settings.

The device may be one wherein widgets are operable to be displayed or not displayed on the second screen in response to the setting of the on/off switch for widgets.

The device may be one wherein instead of having more panes, settings and/or profiles there are simply two modes: to not show or to show widgets on the second screen.

The device may be one wherein if widgets are turned off, they are shown as faded on the configuration screen, and they are not visible on the second screen.

The device may be one wherein the on/off switch for widgets is further operable at some other place in the first screen user interface.

The device may be one wherein the on/off switch for widgets is further operable when turning on or off a device silent mode.

The device may be one wherein the on/off switch for widgets is further operable as a device setting.

The device may be one wherein the second screen displays an alarm clock indicator in response to an alarm clock having been set on the device, and the second screen is not configurable not to display the alarm clock indicator in response to an alarm clock having been set on the device.

The device may be one wherein the second screen displays a critical battery indicator in response to the battery reaching a predefined level, and the second screen is not configurable not to display the critical battery indicator in response to the battery reaching a predefined level.

The device may be one wherein the second display is operable to display a plurality of widgets, wherein the second display is divided into a grid comprising grid elements, wherein each widget is presented using grid elements.

The device may be one wherein grid elements have a lower areal density than pixels of the second display.

The device may be one wherein the grid is a m×n grid, where 2≦m≦20, and 2≦n≦20.

The device may be one wherein the grid is a 4×8 grid.

The device may be one wherein each widgets has a grid element size p×q in the range of 1≦p≦20, and 1≦q≦20, and p≦m and q≦n.

The device may be one wherein widgets can have the size of: 1×1, 1×2, 1×4, 2×2, 2×4, 3×4 or 4×4 of the grid's elements.

The device may be one wherein the second display configuration is operable to be changed via a second display configuration screen on the first display, and the configuration screen is operable to add or edit widgets for the second display.

The device may be one wherein adding or editing widgets for the second display is initiable by long pressing on a portion of the configuration screen without displayed content.

The device may be one wherein adding or editing widgets for the second display is initiable by selecting a selectable menu item.

The device may be one wherein after initiation of adding or editing widgets for the second display, a widget editing menu is provided, wherein the widget editing menu is expandable or collapsible.

The device may be one wherein an icon is provided for switching between the expanded and the collapsed widget editing menu.

The device may be one wherein a user can only switch between the expanded and the collapsed widget editing menu after a user selects a menu item.

The device may be one wherein when a menu item is tapped it is expanded, if not already expanded, and a first available layout alternative for the widget is displayed.

The device may be one wherein the device is operable to receive a user finger swipe, wherein a swipe left or right provides further layout alternatives for the widget.

The device may be one wherein the device is operable to receive a user finger input, wherein a finger tap on a directional arrow provides further layout alternatives for the widget.

The device may be one wherein if a header is pressed on an expanded item, the item is folded.

The device may be one wherein to select a widget and place it on the second screen, the user taps it.

The device may be one wherein if a user taps a new item in the menu list that is not a currently expanded item, the currently expanded item is closed and the new item is expanded.

The device may be one wherein when the user selects to add a widget, and there is not enough space on the second screen for the additional widget, the user is taken to a different screen on which a faded layout preview is displayed and an amount of missing space is indicated.

The device may be one wherein a dialog is presented to inform a user that there is not enough space.

The device may be one wherein a shortcut is presented to go to an edit screen to free up the needed space by either changing the layout of a widget or removing a widget.

The device may be one wherein the second screen is configured automatically to provide enough space for the selected widgets.

The device may be one wherein when the user selects to add a widget, and there is not enough space on the second screen for the additional widget, an option is presented to free up space for the additional widget.

The device may be one wherein when the user selects to add a widget, a grid is presented representing the space on the second screen, and the device is operable to move the widget on the grid and to place the widget on the grid.

The device may be one wherein the widget layout is operable to be edited.

The device may be one wherein the widget layout is operable to be edited by tapping arrows on the screen.

The device may be one wherein when a user is not dragging an object, a done button appears on the screen.

The device may be one wherein if there already are widgets placed on the second screen they are shown faded, to indicate that that space is occupied; any such widget is selectable by tapping on it; the user is able to move such a widget around and change its layout.

The device may be one wherein tapping an empty grid element takes the user to the add widget screen and he can from there add another widget.

The device may be one wherein when an already selected widget is tapped in edit mode, the settings for that widget are opened.

The device may be one wherein a settings icon is provided on top of the widget to indicate that its settings are accessible.

The device may be one wherein all the widget's settings are saved as soon as the user makes them and pressing the Android back-key, in hardware or in software, takes the user back to the widget layout editing screen.

The device may be one wherein the second display is operable to display a plurality of widgets, wherein the widgets are associated with a selectable privacy level, and wherein a layout of the widgets is related to the selectable privacy level.

The device may be one wherein the selectable privacy level is a user selectable privacy level for information shown on the second screen.

The device may be one wherein available layouts of the widgets comprise layout modes of widgets, wherein different layout modes comprise different amounts of information.

The device may be one wherein available layouts of the widgets comprise layout modes of widgets, wherein different layout modes provide the same information arranged differently.

The device may be one wherein a first selectable privacy level provides that private information is provided in detail on the second screen.

The device may be one wherein private information details include full name of caller on missed calls, and name of sender and part of message for new text-based messages.

The device may be one wherein a second selectable privacy level provides that limited private information is provided on the second screen.

The device may be one wherein limited private information includes the number of missed calls and the number of unread messages, but the names of senders and message content are not displayed.

The device may be one wherein a third selectable privacy level provides that only wallpaper is shown on the second screen.

The device may be one wherein when a device is unlocked by a user, the user is offered the option to deselect the first selectable privacy level.

The device may be one wherein the second screen wallpaper is selectable from a menu which is accessible from the home screen pane.

The device may be one wherein if the menu is not displayed on the home screen pane, the menu is operable to be displayed in response to a pressing of a menu key.

The device may be one wherein the menu includes an icon operable to provide selectable wallpaper.

The device may be one wherein selection of the icon operable to provide selectable wallpaper provides a New photo option.

The device may be one wherein the New photo option is selectable to take the user to a camera application for taking and adjusting and cropping the new photo and then selecting the new photo as wallpaper.

The device may be one wherein selection of the icon operable to provide selectable wallpaper provides a wallpaper gallery option.

The device may be one wherein the wallpaper gallery option is selectable to take the user to the Wallpaper gallery to select a wallpaper.

The device may be one wherein selection of the icon operable to provide selectable wallpaper provides a gallery option.

The device may be one wherein the wallpaper gallery option is selectable to take the user to a native gallery application where the user can select, crop and adjust an image.

The device may be one wherein the second screen is configurable to adjust the brightness of the wallpaper and the brightness of widgets.

The device may be one wherein the brightness of the wallpaper and the brightness of widgets are independently adjustable.

The device may be one wherein the brightness of the wallpaper and the brightness of widgets are adjustable in relation to each other.

The device may be one wherein the New photo option provides a wallpaper consisting of a pattern derived from a device camera image.

The device may be one wherein the pattern consists of a tiling of a camera image.

The device may be one wherein when a user is interacting with the first screen, the second screen displays only wallpaper.

The device may be one wherein when a user is interacting with the first screen, the second screen displays no private information.

The device may be one wherein when a user is operating a device function, an image corresponding to that device function is shown on the second screen.

The device may be one wherein when the device function is a camera function, the second screen displays an image of a camera.

The device may be one wherein when the device function is a phone function, the second screen displays an image of a phone.

The device may be one wherein when the device function is a music playing function, the second screen displays a music-related image.

The device may be one wherein the device is operable to provide a deactivated first screen and an activated second screen in response to a user manipulation of the device.

The device may be one wherein a user manipulation includes turning the device around and placing it on a flat surface with the front screen facing down.

The device may be one wherein a user manipulation includes squeezing the sides of the device.

The device may be one wherein a user manipulation includes pressing a side button of the device.

The device may be one wherein a user manipulation includes a device rotation.

The device may be one wherein the device is operable to provide a deactivated first screen and an activated second screen in response to a timeout limit of the device.

The device may be one wherein the device is operable to answer a call in response to a user manipulation including a device rotation.

The device may be one wherein the device is operable to cycle between different privacy levels for display of widgets on the second screen in response to a double tap on the device or on the second screen.

The device may be one wherein if a first selectable privacy level is selected which provides that private information is provided in detail on the second screen, the double tapping cycles between the first, a second privacy level and a third privacy level, wherein the second privacy level provides that limited private information is provided on the second screen, and the third privacy level provides that only wallpaper is shown on the second screen.

The device may be one wherein if a first selectable privacy level is selected which provides that private information is provided in detail on the second screen, the double tapping toggles between a second privacy level and a third privacy level, wherein the second privacy level provides that limited private information is provided on the second screen, and the third privacy level provides that only wallpaper is shown on the second screen.

The device may be one wherein the device provides a selectable option to provide notifications on the second screen.

The device may be one wherein notification includes providing one or more of a received email, a received SMS, a received MMS, a received Facebook message.

The device may be one wherein a notification is displayed for a predefined time, and then the screen returns to a previous state.

The device may be one wherein when a notification is displayed on the second screen, the notification replaces second screen content.

The device may be one wherein when a notification is displayed the device is operable to expand the displayed content of the notification in response to a double tap of a user on the device.

The device may be one wherein when a notification is displayed the device is operable to receive a PIN code via the first screen in response to a double tap of a user on the device, wherein the device is further operable to expand the displayed content of the notification in response to a correct PIN code.

The device may be one wherein following expansion of the notification on the second screen, a message corresponding to the notification is displayed on the first screen in response to the device being turned over.

The device may be one wherein following the display on the first screen of the message, the device is operable for the user to instantly interact with the message.

The device may be one wherein when a notification is displayed the device is operable to dismiss the notification and return the second screen to a previous state.

The device may be one wherein the device is operable to dismiss the notification and return the second screen to a previous state in response to the device being lifted up and returned to its previous position.

The device may be one wherein the device is operable to dismiss the notification and return the second screen to a previous state in response to the device being lifted up on one side and then being let go to return it to its previous position.

The device may be one wherein when no notification is displayed on the second screen, the device is operable to display on the second screen the most recently displayed notification in response to three taps on the device.

The device may be one wherein following display of the most recently displayed notification on the second screen, a message corresponding to the notification is displayed on the first screen in response to the device being turned over.

The device may be one wherein the device provides a selectable option to provide output on the second screen.

The device may be one wherein an incoming voice call to the device is announced on the entire second screen.

The device may be one wherein the front screen is turned on in response to an incoming voice call.

The device may be one wherein no interaction in relation to an incoming call is allowed until the device has been turned over from the second screen to the first screen.

The device may be one wherein interaction with the front screen is supported in response to the device being turned over wherein the first screen faces upwards.

The device may be one wherein the interaction with the front screen is supported irrespective of if the front screen was locked or unlocked before the incoming voice call to the device.

The device may be one wherein user is presented with a screen where the user can swipe to answer a call.

The device may be one wherein the device is operable to answer the call in response to a user swipe down the screen, and the device is operable to decline the call in response to a user swipe up the screen.

The device may be one wherein the user is presented with the options “mute”, “decline” and “send SMS” in response to the user pressing a software Menu button or a hardware Menu button after notification on the second screen of an incoming call.

The device may be one wherein the device requires input of a PIN code in response to selection of either of the options “decline” or “send SMS”.

The device may be one wherein the device displays an overlay of the screen for a predefined time in response to selection of the option “decline”.

The device may be one wherein the device is operable to send a message to the declined caller in response to selection of the option “decline”.

The device may be one wherein the device is operable to clear an overlaid part of the screen in response to a user tap on a non-overlaid part of the screen.

The device may be one wherein the device is operable to receive a mute instruction in response to an incoming voice call to the device being announced on the second screen.

The device may be one wherein the mute instruction comprises the device being lifted up and returned to its previous position.

The device may be one wherein the mute instruction comprises the device being lifted up at one side and let go to return it to its previous position.

The device may be one wherein the device is operable to display a full graphics overlay on the second screen in response to an application running on the device, or to an event occurring at the device.

The device may be one wherein the graphics overlay comprises a phone symbol and the event is an active voice call.

The device may be one wherein no information is shown on the second display in addition to the phone symbol.

The device may be one wherein the graphics overlay comprises a camera skin and the application is a camera application.

The device may be one wherein the camera skin is user selectable.

The device may be one wherein the graphics overlay comprises a music-related skin and the application is a media player.

The device may be one wherein the skin is user selectable or predetermined, depending on the media played.

The device may be one wherein the event occurring at the device is a low power level, and the graphics overlay indicates a low power level.

The device may be one wherein the second screen is operable to display a wallpaper, and wherein an application which provides the wallpaper for display is operable to change the displayed wallpaper without user intervention.

The device may be one wherein the application which provides the wallpaper for display changes the displayed wallpaper in response to activating events.

The device may be one wherein an activating event is one or more of: device location, time, calendar events, weather, weather in combination with location.

The device may be one wherein the wallpaper is changed at a low rate.

The device may be one wherein the wallpaper is changed very slowly.

The device may be one wherein the first screen is a touch screen, and the first screen is operable to be unlocked by a touch gesture in which a finger starts at either the top or bottom of the screen and moves towards the centre of the screen.

The device may be one wherein the finger must pass a predefined distance up or down the screen in order to complete the unlock.

The device may be one wherein the distance is half way down the screen.

The device may be one wherein the finger must achieve a threshold speed in order to complete the unlock.

The device may be one wherein the finger starts at the top of the screen.

The device may be one wherein there is an inactive area between a top capacitive area and the screen edge to separate unlock gesture from status menu gesture.

The device may be one wherein the first screen is a touch screen, and the first screen is operable to be locked by a touch gesture in which a finger starts at either the top or bottom of the screen and moves towards the centre of the screen.

The device may be one wherein the direction of the finger for the lock gesture is the opposite to the direction of the finger for a corresponding unlock gesture.

The device may be one wherein the finger must pass a predefined distance up or down the screen in order to complete the lock.

The device may be one wherein the distance for the lock is half way down the screen.

The device may be one wherein the finger must achieve a threshold speed in order to complete the lock.

The device may be one wherein for the lock the finger starts at the bottom of the screen.

The device may be one wherein the device is a slate device.

The device may be one wherein the device is a bar or candybar device.

The device may be one wherein the device is a slab-shaped form.

The device may be one wherein the first display screen is a liquid crystal display screen.

The device may be one wherein the device is portable.

The device may be one wherein the device is a mobile phone, a portable digital assistant, a laptop, a digital audio player (eg. ipod), or a tablet computer (eg. ipad).

The device may be one wherein the device includes a virtual keyboard.

The device may be one wherein the device includes a concave front face and a convex rear face.

According to a second aspect of the invention, there is provided a method of operating the device, comprising the step of the device receiving user input.

According to a third aspect of the invention, there is provided a method of operating the device, comprising the step of the device changing what is displayed on the device.

According to a fourth aspect of the invention, there is provided a computer program product operable when running on the device to enable the device to receive a user input to the device.

According to a fifth aspect of the invention, there is provided a computer program product operable when running on the device to change what is displayed on the device.

### BRIEF DESCRIPTION OF THE DRAWINGS

FIG. 1 shows an example of a mobile device industrial design.

FIG. 2 shows an example of a mobile device industrial design.

FIG. 3 shows the front face, back face and side view of an example device in the same Figure. The device is shown in the off state or in a low power state.

FIG. 4 relates to Accessing the EPD pane (the “6th pane”).

FIG. 5 relates to Accessing the EPD pane (the “6th pane”).

FIG. 6 relates to Accessing the EPD pane (the “6th pane”).

FIG. 7 relates to the EPD configuration screen.

FIG. 8 relates to the EPD configuration screen.

FIG. 9 relates to the function Enable/Disable EPD widget switch.

FIG. 10 relates to EPD grid and system controlled elements.

FIG. 11 relates to Widget Layouts.

FIG. 12 relates to EPD screen examples.

FIG. 13 relate to the Available widgets list.

FIG. 14 relate to the Available widgets list.

FIG. 15 relate to the EPD pane edit mode.

FIG. 16 relate to the EPD pane edit mode.

FIG. 17 relates to widget settings.

FIG. 18 relate to setting wallpaper.

FIG. 19 relate to setting wallpaper.

FIG. 20 relates to EPD screen modes.

FIG. 21 relates to interaction on the EPD screen.

FIG. 22 relates to interaction on the EPD screen.

FIG. 23 relates to interaction on the EPD screen.

FIG. 24 relates to incoming event notification.

FIG. 25 relates to incoming event notification.

FIG. 26 relates to incoming event notification.

FIG. 27 relates to an incoming call.

FIG. 28 relates to an incoming call.

FIG. 29 relates to an incoming call.

FIG. 30 relates to back screen use cases.

FIG. 31 shows a screen example relating to Accessing the EPD pane (the “6th pane”).

FIGS. 32 and 33 each shows a screen example relating to the EPD configuration screen.

FIGS. 34 and 35 each shows a screen example relating to the function Enable/Disable EPD widget switch.

FIG. 36 shows a screen example relating to EPD grid and system controlled elements.

FIGS. 37 to 39 show screen examples relating to Widget Layouts.

FIGS. 40 to 42 show screen examples relating to EPD screen examples.

FIGS. 43 to 46 show screen examples relating to the Available widgets list.

FIGS. 47 to 51 show screen examples relating to the EPD pane edit mode.

FIGS. 52 to 54 show screen examples relating to widget settings.

FIGS. 55 to 57 show screen examples relating to EPD screen modes.

FIGS. 58 to 60 show screen examples relating to incoming event notification.

FIGS. 61 to 64 show screen examples relating to an incoming call.

FIG. 65 illustrates gestures suitable for locking or unlocking a touch screen mobile communications device. (eg. a phone).

FIG. 66 is from the prior art publication US2008002115A1. In this Figure there is disclosed a display stack-up 300 which is provided for a mobile electronic device 100 having an internal and external display, for example a clamshell style mobile phone.

FIG. 67 is from the prior art publication US2008002115A1. In this Figure it is disclosed that the mobile electronic device 100 includes a first housing member 102 and a second housing member 104. The first housing member 102 and the second housing member 104 may be made up of materials like metal, plastic, glass and/or hybrids thereof. The first housing member 102 and the second housing member 104 are hingedly connected with one another and are configurable in the open and closed positions.

FIG. 68 is from the prior art publication US2008002115A1. This Figure shows the hinged mobile phone disclosed therein in the closed configuration.

### DETAILED DESCRIPTION

### Dual Screen Phone

In an example, there is provided a dual screen bar form factor phone with a bi-stable display. An advantage of a dual screen bar form factor phone is that one screen is always visible, whichever way up the device is placed on a table. By displaying an incoming message on both screens, this ensures that incoming messages are always visible when the device is lying on a table. The first display screen may use electrowetting technology. The second display screen may use electrowetting technology eg. Liquavista.

The device appearance may be context-related eg. in relation to position such as one determined using a global positioning system (GPS) receiver, or in relation to weather, or in relation to temperature, or in relation to time of day. Context related (eg. position-related) device appearance may include location-based advertising. Context related (eg. position-related) device appearance may include results of a location-based search.

Notification and customization are important tasks in mobile computing. For notification it is known to use sound, vibration or LCD/AMOLED (liquid crystal display/Active-matrix organic light-emitting diode) displays. All those ways provide notification for a limited time and cannot work in always-on mode due to high power consumption. There are cases with segmented bi-stable displays used for notifications, but they don't give right flexibility with notification messages or/and options.

There are many ways for customization of the device—pictures and themes for user interface (UI) on main screen, sounds and different accessories like phone cases can be used to change the look of the device. The look of the device can be changed by changing what is displayed on the bi-stable screen, such as to give the appearance of a different phone case for example. For example, the phone skin can be changed. The phone skin may be one or more of wallpaper, photos, movies, user-customized content.

In an example, there is provided a bi-stable active matrix and high-resolution display on the back panel of the device. This improvement gives the following advantages in relation to prior art cases:
Phone customization—user is able to display any pattern, picture or application interface to differentiate their phone from others
Notifications—any application or service is able to display the notification on the back screen. Notification time is not limited, because a bi-stable display is used.
Notifications—any application or service is able to display the notification on the front screen. The notification such as a message may be provided on the front screen and on the back screen,
The information remains on the screen even when the phone itself is switched off. This is important even for manufacturing—a manufacturer can place all needed information directly on the bi-stable screen: eg. serial number, certification logos, country of origin and so on.

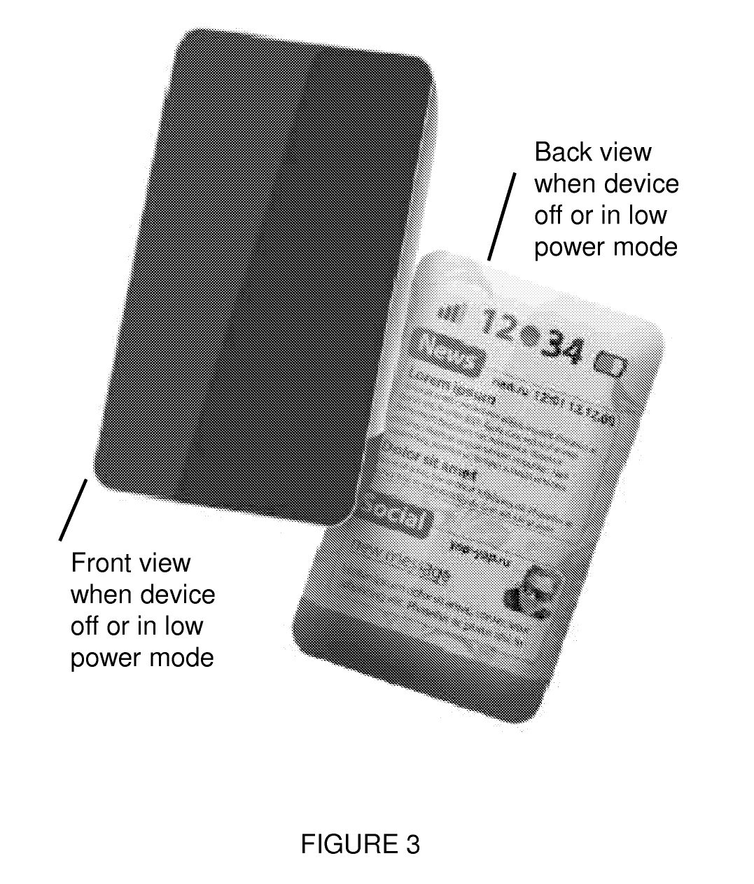

An example of a device which may implement the invention is shown in FIG. 3. FIG. 3 shows the front face and back face of an example device which may implement the invention in the same Figure. The device is shown in the off state or in a low power state. In the off state or in a low power state, the front face is not illuminated: it is shown as dark. However, in the off-state or in a low power state, the bi-stable display on the back face continues to display content, which can be viewed as a result of external illumination eg. ambient illumination. In an example of FIG. 3, the front face has an AMOLED display, and the back face has an E-ink bi-stable display.

A bi-stable display may use interferometric modulation technology eg. Qualcomm Mirasol.

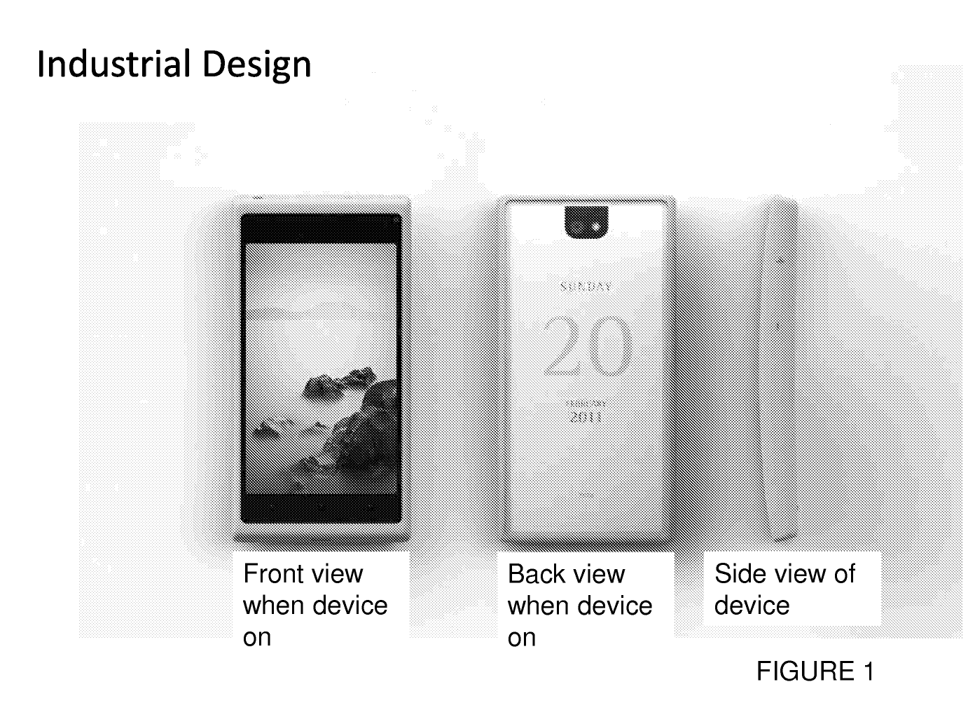

An example is shown in FIG. 1. FIG. 1 shows in the same Figure the front face and the back face of an example device which may implement the invention. The device is shown in the on state. In the on state, the front face is illuminated and can display an image or other content. In the on-state, the bi-stable display on the back face also can display an image or other content. In an example of FIG. 1, the front face has an AMOLED display, and the back face has an E-ink bi-stable display. FIG. 1 shows a side view of an example.

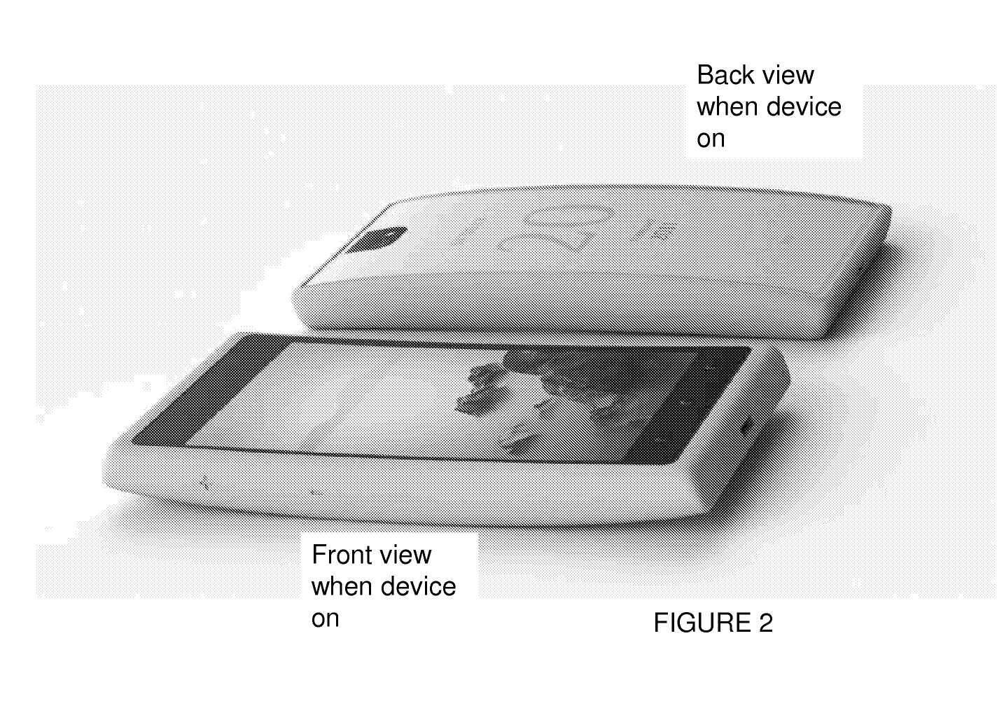

An example of a device which may implement the invention is shown in FIG. 2. FIG. 3 shows in the same Figure the front face and the back face of an example device which may implement the invention. The device is shown in the on state. In the on state, the front face is illuminated and can display an image or other content. In the on-state, the bi-stable display on the back face also can display an image or other content. In an example of FIG. 2, the front face has an AMOLED display, and the back face has an E-ink bi-stable display.

An example of the front display is: 4″ WVGA (800×480 Or 854×480)

Technology: AMOLED or sIPS/FFS
Nissha Capacitive touch screen

### Glass: Gorilla Glass (Corning)

An example of the back screen is: Electronic Paper Display under glass on back side (E-INK).

Properties of the back face may include:
E-INK Back screen
Sharp Greyscale panel
Perceived as part of case
Low power consumption

Properties of the back screen may include:

### 1. Image

Resolution: 700˜900×480 (possible target: similar to front display)
Colors: 16 Grey scale (E-ink) or 65K (LG)
Contrast: 10:1˜20:1, Reflective ratio: 40%+
Refresh ratio: 150 ms˜400 ms
Ability to refresh any area starting from 1 pixel
Color scheme conforms to case color

### 2. Power Consumption

Approximately 1000 full screen updates using 300 mAh of charge
To minimize power consumption, update rate should be minimized to the order of twice per minute
Does not consume/require power when in bi-stable state

The back screen output may provide:
Interactions,
Control,
Use cases,
Personalization,
Widgets, (widgets may be understood with reference to Appendix 4)
Privacy

An example of interactions is text messages from a blog site. An example of control is varying the frequency of back screen updates eg. from once per minute to once per 5 minutes. An example of use cases is receipt of a major emergency notification by an emergency services worker. An example of personalization is putting a photo of a favourite landmark on the back screen. An example of privacy is removing names of companies or individuals from any received incoming message displayed on the back screen.

A bar form factor display device may be one wherein the back display screen output provides a social network screen.

Preinstalled Widgets may include: Clock, Social aggregator, Communications Log, “Favorites” Bucket, News, Weather, Yota Connection, Battery, Contacts Favorites, Latitude & Longitude, and Player.

The Back Screen may provide:
Context related Themes (Weather, Location, Environment)
Widgets, Notifications
Personalization
Post cards
Operator Push (Congratulations, Customer info)

The back display of the device may display news provided by a news service. The back display of the device may display social messages provided by a social messaging service. The back display of the device may display output providing social aggregator output or social network output. The social aggregator output or social network output may be a Facebook page. The back display of the device may display a Google search page. The back display of the device may display an indication of mobile phone signal strength. The back display of the device may display an indication of battery charge state. The back display of the device may display calendar information.

The back display of the device may be the only operational display of the device when the device operates in a low power notification mode. When the device operates in a low power notification mode the back display of the device may be updated in response to an incoming news story provided by a news service. When the device operates in a low power notification mode the back display of the device may be updated in response to an incoming social message provided by a social messaging service. The device may be programmed such that when the device operates in a low power notification mode, the back display of the device displays content updates of one or more categories, for example, news, social messages, an emergency notification, financial news, earthquake, tsunami or weather. The categories may be preselected, such as by a user or by a network services provider.

### Further Aspects of the Mobile Device

The mobile device may be portable. The mobile device may be a mobile phone, a portable digital assistant, a laptop, a digital audio player or a tablet computer. Known digital audio players include the ipod and mp3 players. Known tablet computers include the ipad. The device may include a virtual keyboard. The device may have a touch screen. The device may have two screens each of which is a touch screen. A screen may be bi-stable; a bi-stable screen may be a touch screen. A screen that is not a bi-stable screen may be a touch screen. The device may include a second bi-stable screen. The device may include a second bi-stable screen which is a touch screen. The device may include a second bi-stable screen which is not a touch screen.

A screen may occupy greater than 50% of the area of the major face of the device on which it is located. A screen may occupy greater than 60% of the area of the major face of the device on which it is located. A screen may occupy greater than 70% of the area of the major face of the device on which it is located. A screen may occupy greater than 80% of the area of the major face of the device on which it is located. A screen may occupy greater than 90% of the area of the major face of the device on which it is located. A screen may occupy greater than 95% of the area of the major face of the device on which it is located.

The device may comprise a single backlight module situated between its two major faces. The backlight module may illuminate one display on one major face. The backlight module may illuminate two displays each of which is situated on a different major face of the device to the other display.

The device may comprise two backlight modules, each of which may illuminate a display situated on a major face of the device. Each backlight module may illuminate a respective display on a respective major face of the device. The two backlight modules may be situated between two displays of the device, where each display is situated on a different major face of the device to the other display.

The device may have flat (i.e. non-curved) front and back major faces. The device may have one major face that is curved with the other major face being flat (i.e. non-curved).

The device may comprise a normal power display (eg. LCD, AMOLED), which drains battery power too much for the normal power display to operate in a mode in which it can display content at all times, and a low power display which is better suited, or ideally suited, to operate in a mode in which it can display content at all times (eg. a bistable display, or a greyscale panel).

Curved Bar Form Factor Display Device (eg. Phone)

The bar form factor display device (eg. a phone) may have a unique and organic shape—essential for rapid product differentiation in a crowded space. Examples are shown in FIGS. 1 and 2. The bar form factor display device may have a concave front face and a convex rear face. The magnitude of the curvature of the faces may be the same or similar. The concave front may match the path of a finger as the user's wrist rotates. Hence it's very natural to use. Having a curved surface as the vibrating distributed mode loudspeaker (DML) speaker is also better since if the front display with the speaker exciters was instead a flat surface, then it would sound unpleasant if that flat surface is placed down against a tabletop. Curving the surface prevents this happening. Preferred curvature of front and back is cylindrical, but spherical or aspherical are possible. The convex back can have a bistable display. Since the normal resting position is front face down, the back screen with bi-stable display is normally displayed when bar form factor display device is in the resting position. This resting position is mechanically stable. If bar form factor display device is placed back down (ie convex face down), the bar form factor display device could spin, which is unstable. Hence a user will likely place bar form factor display device front face (i.e. concave face) down, with the bi-stable screen showing.

If the bar form factor display device is in a pocket, the front face (concave face) can face inwards, since this better matches leg curvature. This can be the better configuration (as opposed to front face up) for antenna reception.

In manufacturing, the curved shape may be laminated to glass.

The mobile phone may be connected to a 4G mobile phone network. The mobile phone may be connected to a 3G mobile phone network. The mobile phone may be connected to a 2G mobile phone network. The mobile device may be connected to a 4G mobile phone network. The mobile device may be connected to a 3G mobile phone network. The mobile device may be connected to a 2G mobile phone network.

The mobile device (eg. mobile phone) may be a bar form factor device. The device case may be a single block. The device may have a touch screen. The device operating system may be Google Android. The device may have a bistable screen. The device may have a touch screen and a further bistable screen. The bistable screen may be one which can be refreshed wholly or partially, such as for a limited screen area or the whole screen area, starting with any pixel in that screen area. A glass substrate of the device may be curved in conformity with device surface curvature.

The bar form factor display device may comprise a plurality of display screens. Bar form factors include slab, slate, block, bar and candybar. Bar form factor display devices, eg. slate devices such as the iPhone™ and the iPad™, are known. However, these devices comprise only a single display screen. A bar form factor device may be a slate device.

The mobile device (eg. mobile phone) may be used to define a limited set of users who may connect to the device to enable instant and automatic sharing of a WiFi network with the limited set of users.

The mobile device (eg. mobile phone) may provide a wireless connection to a personal computer, to enable that computer to connect to the internet.

The mobile device (eg. mobile phone) may provide a wireless connection to two personal computers, to enable file sharing or resource sharing (eg. sharing of application software) between those two personal computers via a trusted intermediary: the mobile device.

The mobile device (eg. mobile phone) may provide for file synchronization for files that are shared using automatic sharing of a WiFi network via the mobile device.

The mobile device may be a personal computer, a video game console, a smartphone, a digital audio player, a mobile phone or a tablet computer, for example. The mobile device may include an integral GPS antenna.

The mobile device (eg. mobile phone) may provide instant and automatic sharing of a wireless network in response to a single action by a user, the single action comprising a physical contact gesture by the user with the mobile device, or a voice activation command, when the device is already turned on and connected to a mobile phone network. Sharing may be with a device of another user, or with a plurality of other user devices.

User Interface Interaction Design: Controlling and Customizing the Back Display eg. The Electronic Paper Display (EPD)

Although this example is given for an EPD, the skilled person will understand that any low power display technology may be used in the place of an EPD on the back side of the mobile display device.

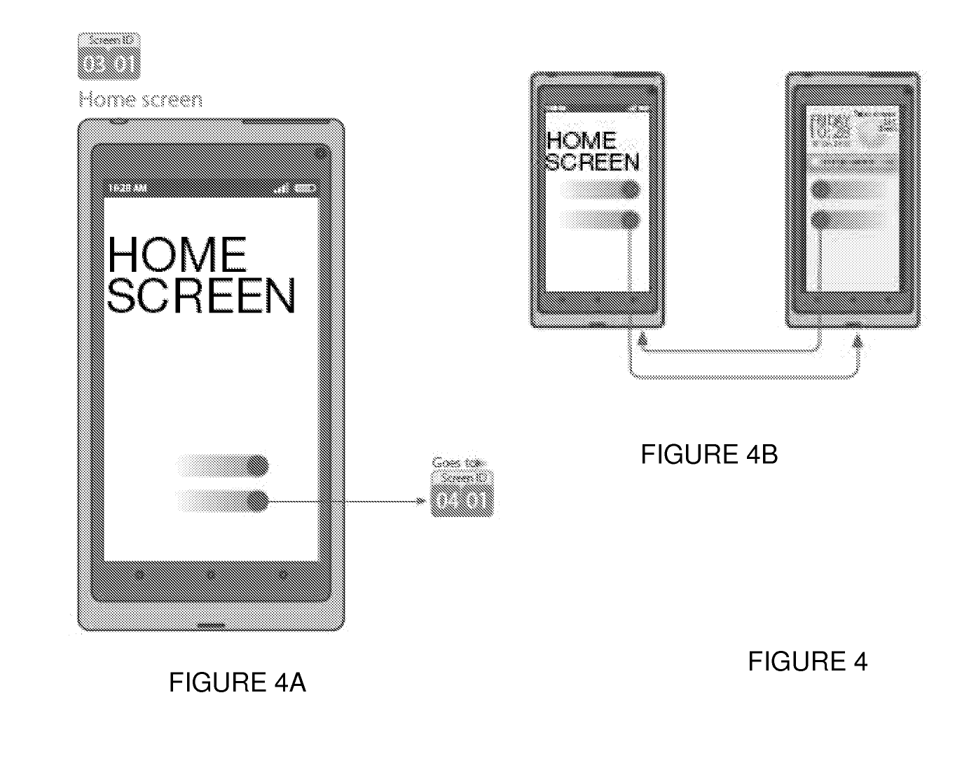

FIGS. 4 to 6 relate to Accessing the EPD pane (the “6th pane”).

FIG. 4A shows the standard home screen on the front screen. To directly access the EPD pane (6th pane) the user can swipe to the right with two fingers across the screen. Once at the 6th pane the user could perform a two finger swipe again (in either direction (left/right)) to instantly return to the previous panel, as shown in FIG. 4B.

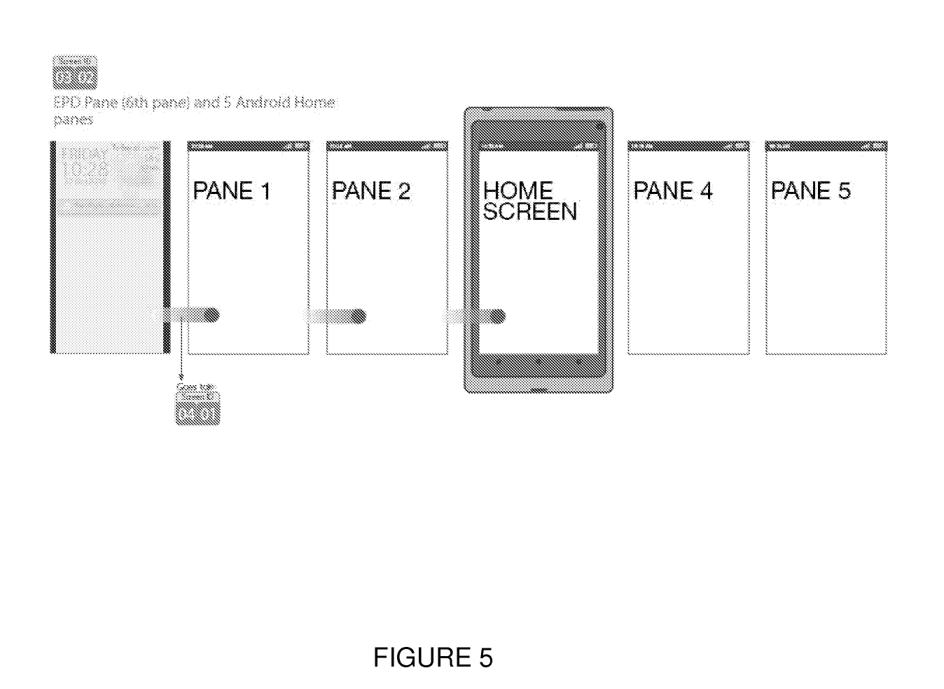

FIG. 5 shows that the EPD pane is located at position zero in relation to the other five Android home panes. Besides the two finger swipe, it can be accessed by swiping through the other screens.

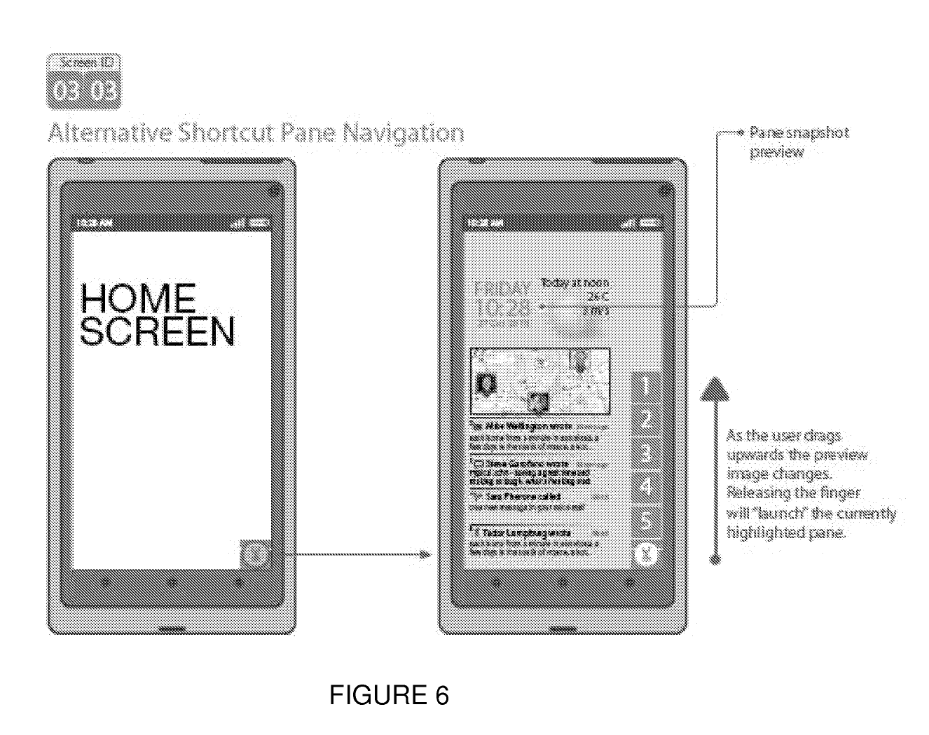

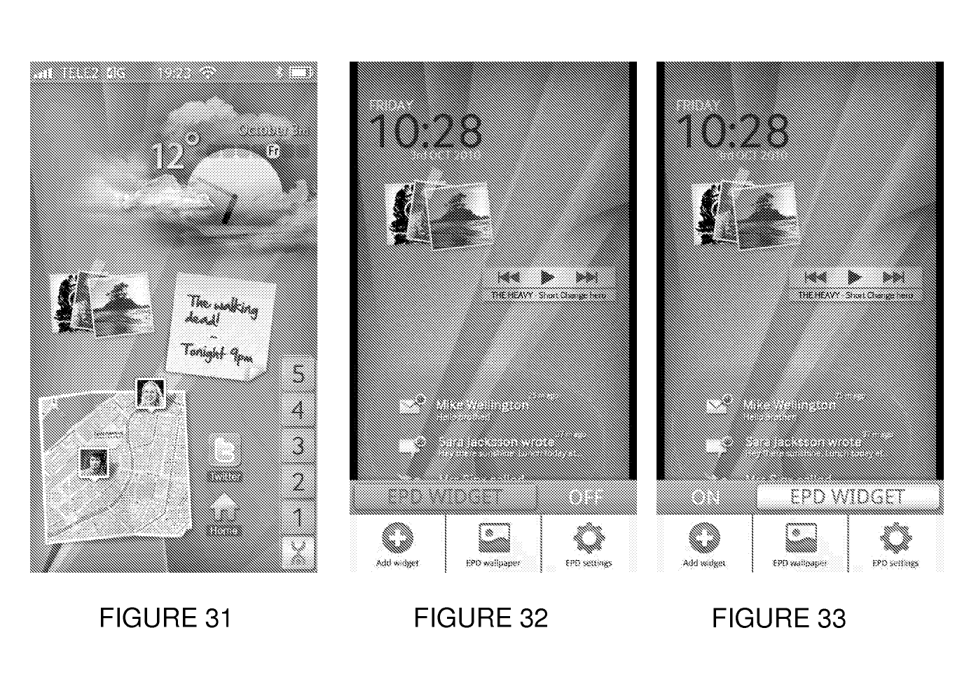

FIG. 6 shows an alternative shortcut pane navigation. For the screen on the left hand side of FIG. 6, at the very bottom right corner a shortcut icon is found. Pressing on this icon will enable the user to quickly jump to another pane, such as is shown in the right hand side of FIG. 6. In the right hand side of FIG. 6, the user has initiated the “quick jump” function and is presented with a preview of the “6th pane”. The user can then drag upwards to reach any of the other five panes (see FIG. 5). In the right hand side of FIG. 6, as the user drags upwards, the preview image changes. Releasing the finger will “launch” the currently highlighted pane. A pane snapshot preview is indicated at the top of the right hand side of the screen in FIG. 6. An example of the right hand side of FIG. 6 is shown in FIG. 31.

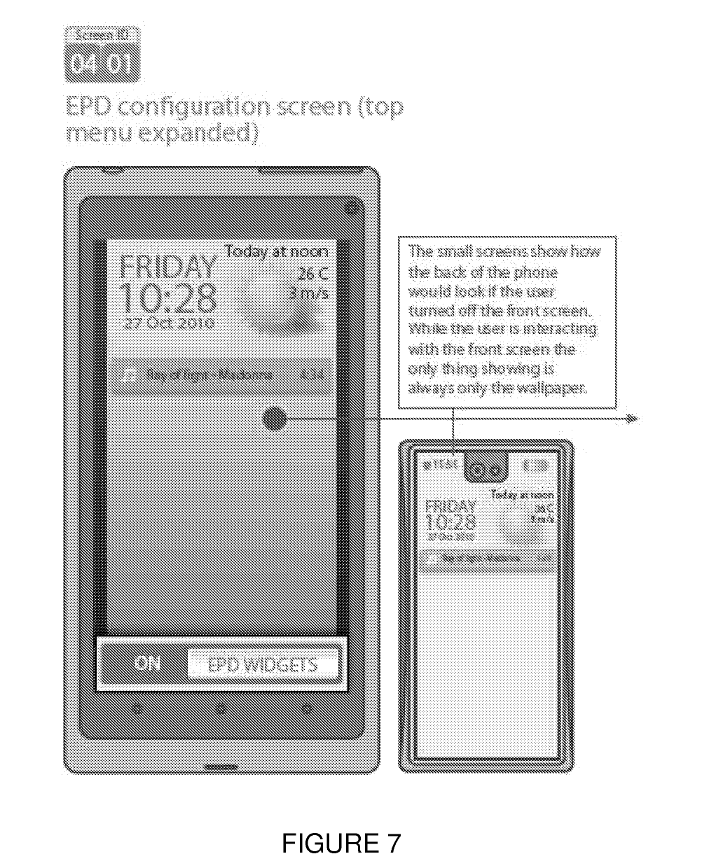

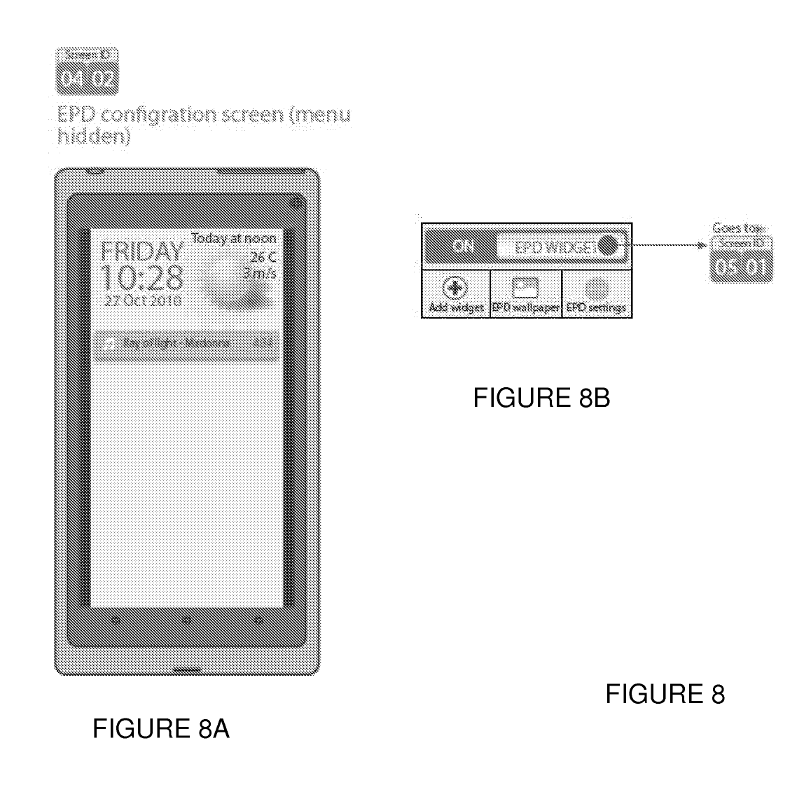

FIGS. 7 to 8 relate to the EPD configuration screen. (Examples are shown in FIGS. 32 and 33).

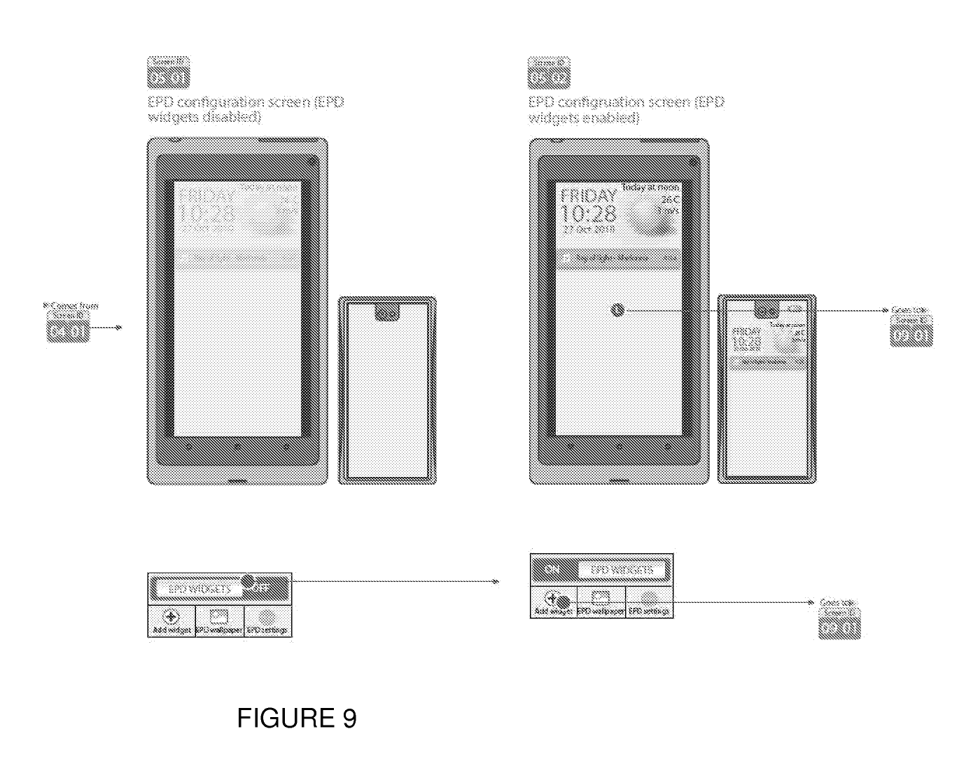

FIG. 7 shows the EPD configuration screen. It displays a replica of the actual EPD with the top part removed. If you look closely at FIG. 7, you can see that the items at the top of the right hand EPD screen “15:55” and the battery charge state indicator are not present in the left hand EPD configuration screen on the device front display. The top part is removed to give the user a less downscaled mirror of the EPD (the user is not able to place widgets on the top part anyway). When the user enters this screen the top part of the options menu is displayed containing the EPD widgets on/off switch. (This switch will be described further in the section relating to “Enable/Disable EPD widget switch”: see FIG. 9 and its associated description). When the user taps elsewhere on the screen, the menu is folded. (Having the top part of the menu automatically displayed is an optional feature. Removing it would simply take the user directly to screen 0402.) In FIG. 7, the small screen shows how the back of the phone would look if the user turned off the front screen. While the user is interacting with the front screen the only thing showing is always only the wallpaper.

FIG. 8A shows the Configuration screen with the menu folded.

Pressing the [Menu]-key brings the menu back up looking like FIG. 8B.

FIG. 9 relates to the function Enable/Disable EPD widget switch. (Widgets may be understood with reference to Appendix 4).

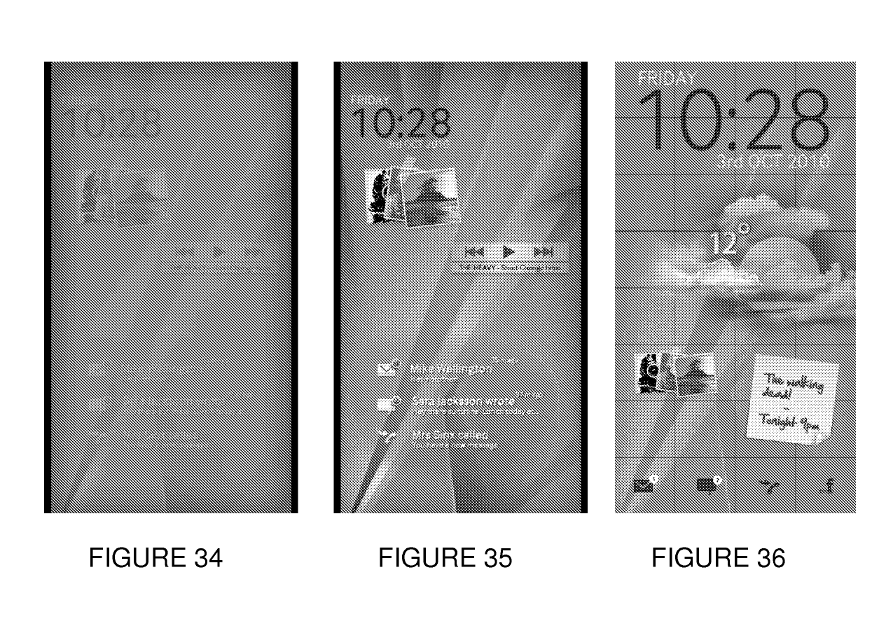

FIG. 9 left hand side shows the EPD configuration screen with widgets disabled. The currently added widgets are displayed but faded to indicate that they are not currently visible on the back of the phone (an example is shown in FIG. 34). This feature is controlled by the previously mentioned EPD widgets switch in the options menu, shown in the bottom left of FIG. 9. The purpose of having an on/off switch for EPD widgets is to give the user an easy way of being and feeling in control of the content on the back of the phone. Instead of having more panes, settings and/or profiles, there are simply two modes: to not show or to show widgets on the back.

Controlling EPD widgets on/off could also be done from other parts of the user interface (UI). For example when setting the phone to silent mode there is also an option to enable/disable EPD widgets.

In the right hand side of FIG. 9, EPD widgets are now activated and to add a widget the user can longpress the background or press the [menu]-key and then the add widget item in the menu. An example is shown in FIG. 35.

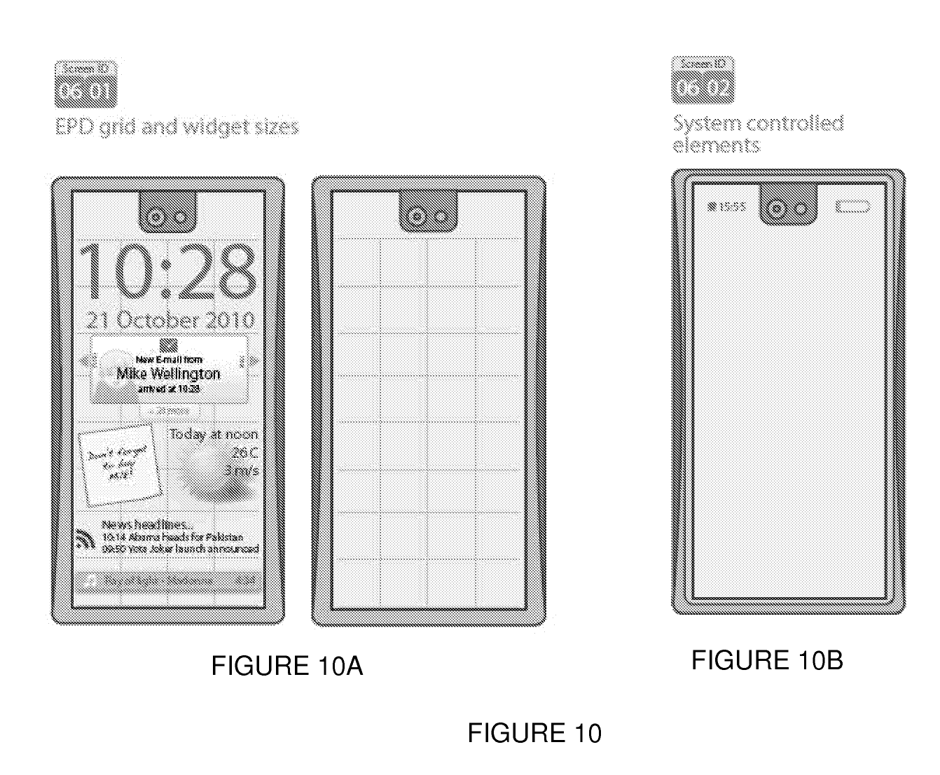

FIG. 10 relates to EPD grid and system controlled elements. In FIG. 10A, the EPD display is divided into a 4×8 grid and widgets can have the size of: 1×1, 1×2, 1×4, 2×2, 2×4, 3×4 or 4×4. An example is shown in FIG. 36.

In FIG. 10B there are only two different types of information that are not controlled by the user. Those are:

Alarm indicator (FIG. 10B top left of screen) and Critical Battery level (FIG. 10B top right of screen).
The alarm indicator is only displayed if the user has set an alarm.
The Critical Battery level indicator is only displayed if the battery has reached a critical level (eg. according to Android parameters).

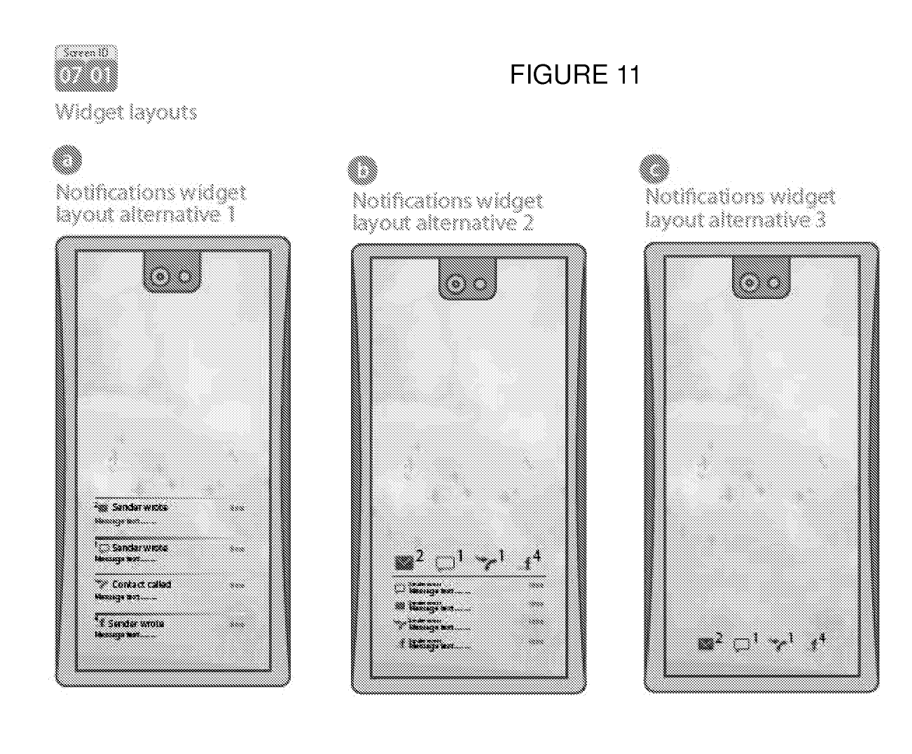

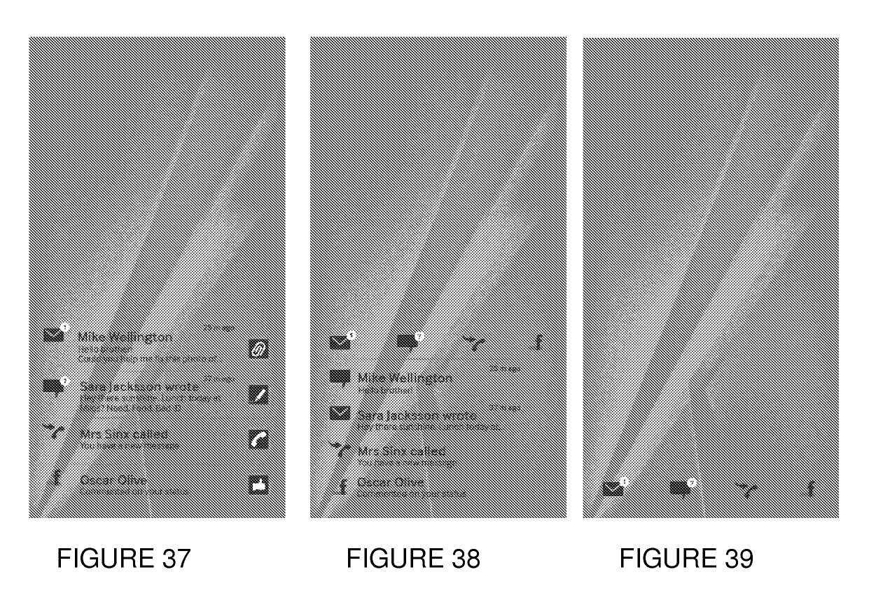

FIG. 11 relates to Widget Layouts. In terms of privacy it is completely up to the end user to decide what he puts on the EPD. To make it flexible for the user widgets will have different layouts; these can both contain a variable amount of information or display the same information in different ways. In (a), this layout takes up more space but provides the user with more information. In (b), this layout displays the same information as the (a) one but takes up smaller space. In FIG. 11, (a) and (b) illustrate that different widget layouts do not necessarily have to contain different amounts of information. In (c), this layout takes up smaller space and is also more suitable for a user demanding higher privacy as it does not show any names of senders. Further examples are shown in FIGS. 37, 38 and 39.

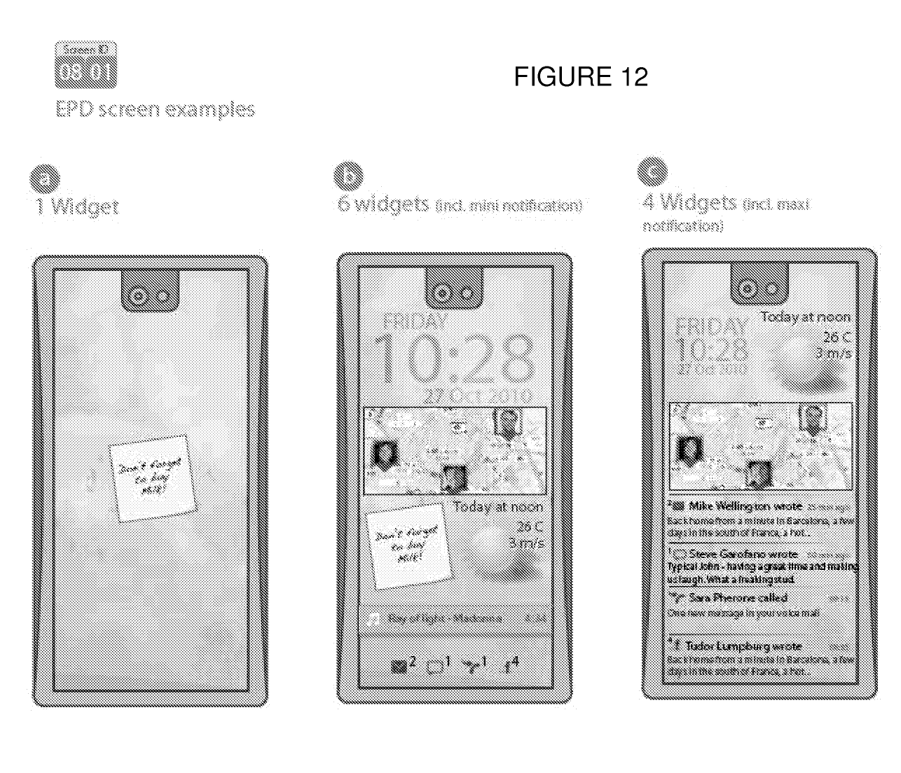

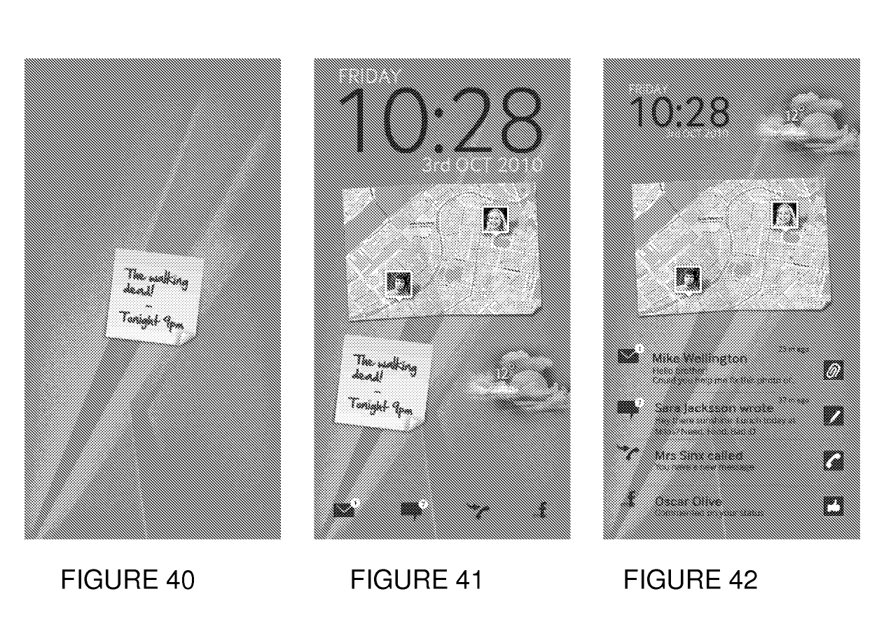

FIG. 12 relates to EPD screen examples. In FIG. 12 there are shown some different examples of what the EPD could look like depending on what widgets the user has added. Notice that screen “c” has added a widget that shows actual messages received via facebook/SMS etc. as well as showing a localization based widget, hence the “c” screen would be the one with a very high public level (low privacy). Further examples are shown in FIGS. 40, 41 and 42.

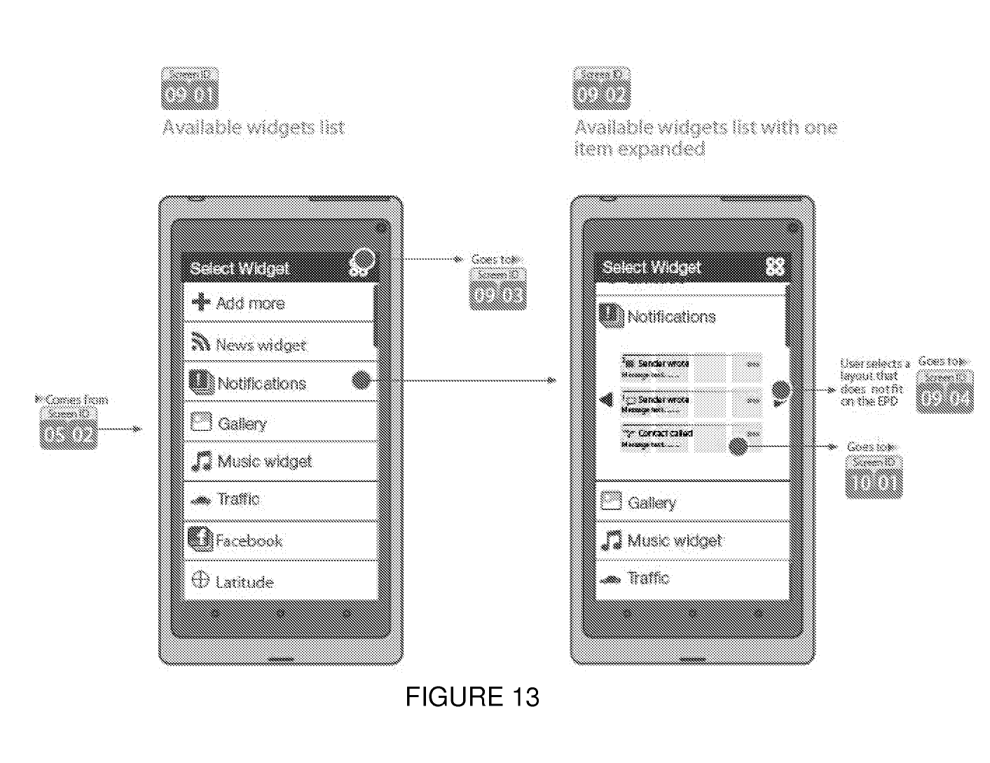

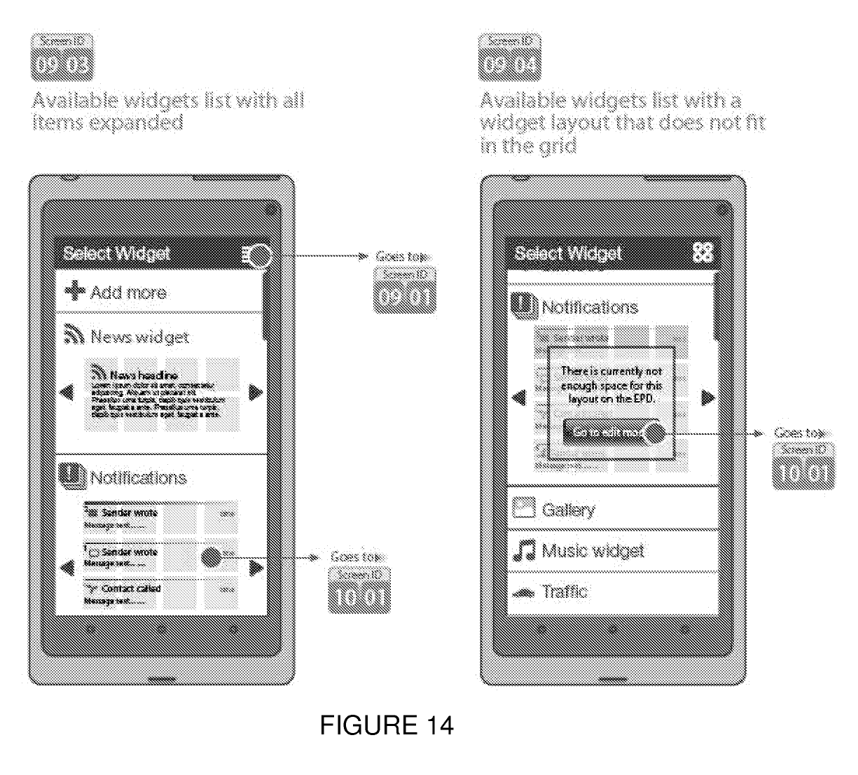

FIGS. 13 and 14 relate to the Available widgets list. In the left hand side of FIG. 13 (screenID 0901), the user has longpressed the background or selected “add new widget” from the menu and is presented with a list with all the available widgets. The button in the header switches the list between expanded and collapsed. This enables the user to both get a quick overview of the available widgets and go more in-depth to view the visual previews. The first time the user enter this screen, the list may be expanded to screen ID [0903].

In FIG. 13, in the right hand screen (screen ID 0902), when an item is tapped it is expanded and the user can browse through different widget layout alternatives by swiping left or right or tapping the arrows. If the header is pressed on the expanded item, it is folded. To select a widget, and place it, the user taps it. If a user taps another item the currently expanded one is closed and the new item is expanded. If there is not enough room on the EPD for the current layout: see screen ID [0904] in FIG. 14.

In FIG. 14 in the left hand screen, when the user has pressed the “expand all” button, all items are expanded. Pressing the button now takes the user back to screen ID [0901]. An option to consider is simply removing the expanded/folded switch and choosing one of these modes [0901]+[0902] or [0903]. This is something that highly depends on number of available EPD widgets, for a list with few items this solution [0903] might be preferable and vice versa.

In FIG. 14 right hand screen, this screen shows what is displayed if there is not enough space on the EPD for the current layout. The layout preview is faded and the amount of missing space is marked eg. with a different colour. A dialog is also displayed to inform the user why the current layout is unavailable. He is also presented with a shortcut to the solution which is to go to the edit mode (screen [1001]) where he can free up the needed space by either changing the layout of another widget or removing it. An option could be to automatically add this layout directly in the edit mode when the user has freed up enough space or to simply do this automatically.

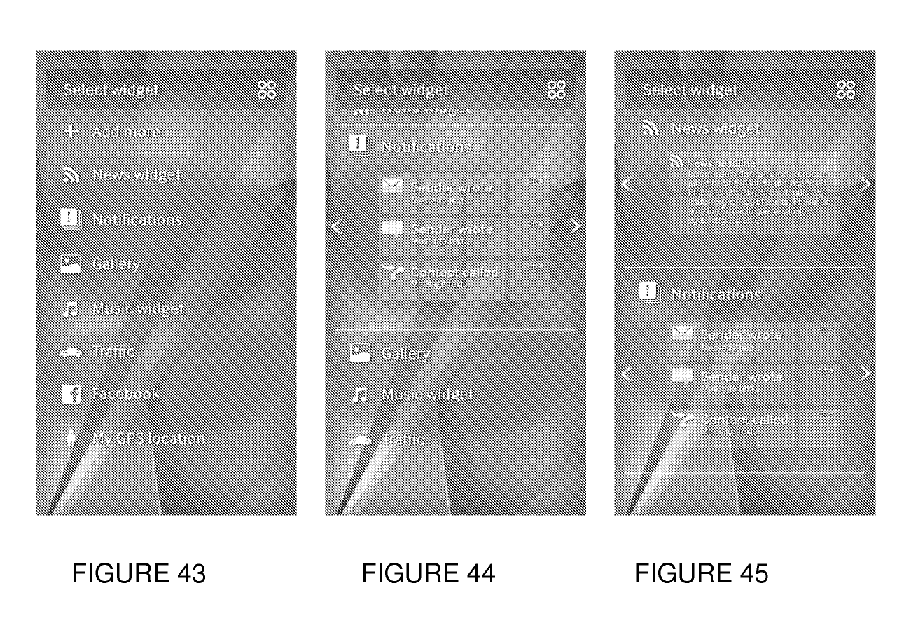

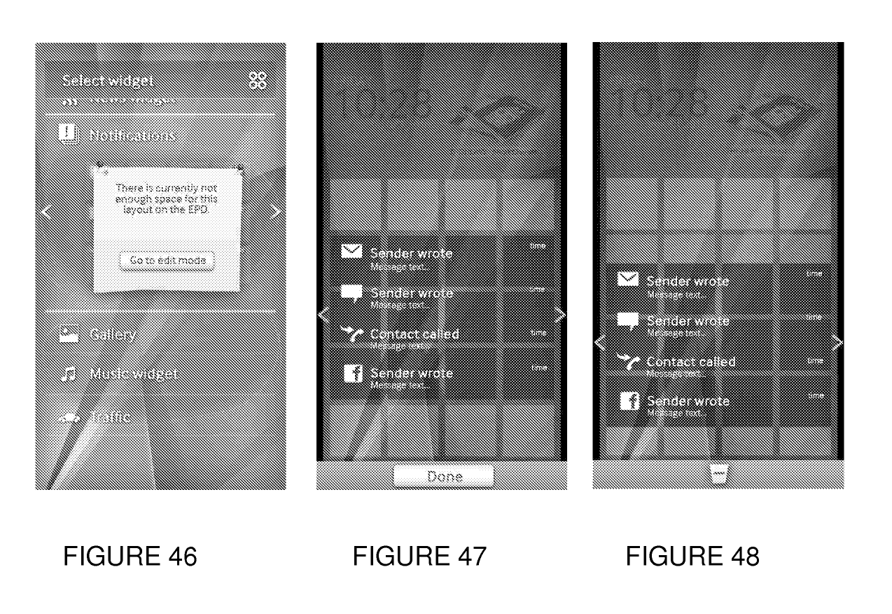

Examples relating to FIGS. 13 and 14 are shown in FIGS. 43 to 46.

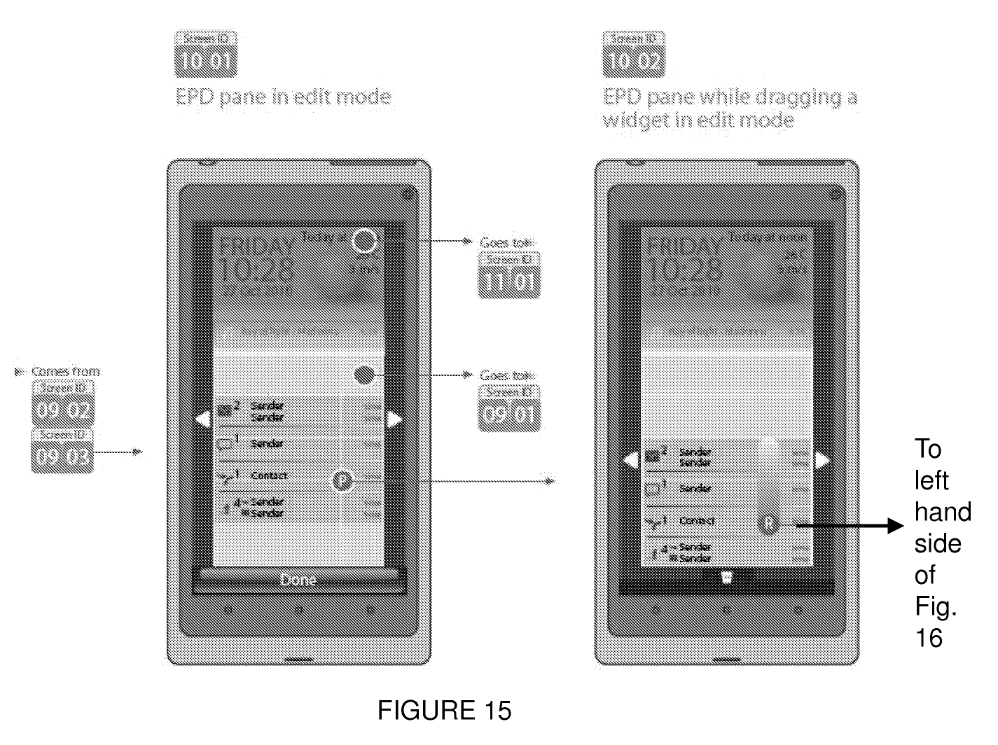

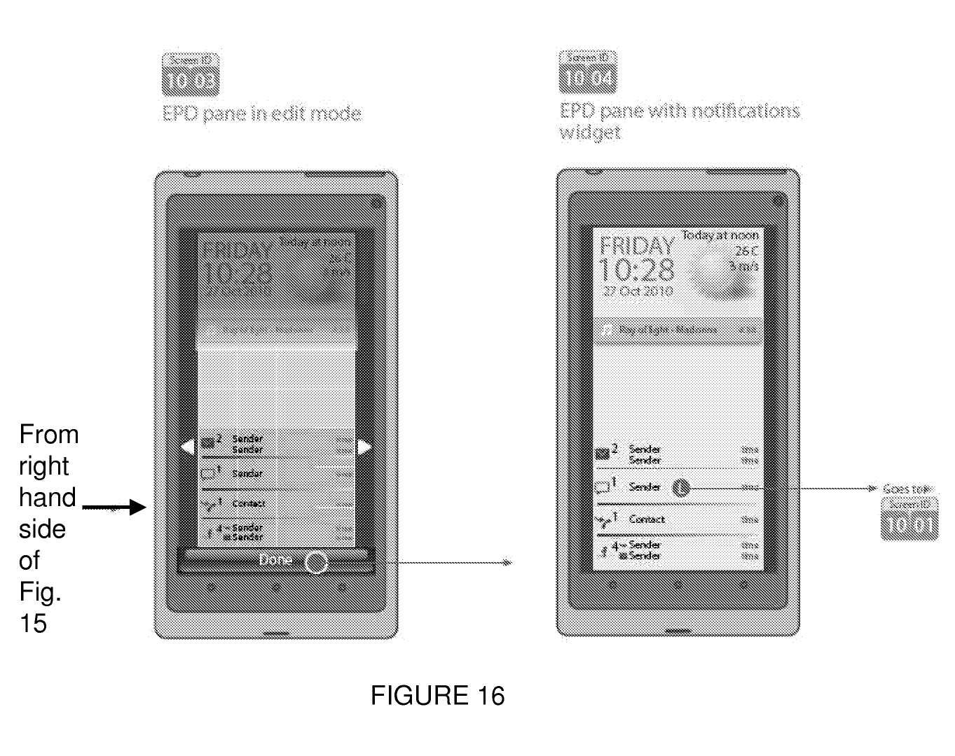

FIGS. 15 and 16 relate to the EPD pane edit mode. In the left hand side of FIG. 15, when the user has selected a widget he is presented with a grid and can move the widget around and place it. He can also in this mode change the layout of the widget by tapping the arrows on the sides. When the user is not dragging an object a done button appears at the bottom of the screen. In this mode the user can also tap another widget to move it around or change its layout. Tapping an empty grid takes the user to [0901] and he can from there add another widget. Other widgets are faded to indicate that that space in the grid is occupied. All changes made in the edit mode are saved instantly when the user has done them. One thing to take into consideration is the option to remove the done button and just leave this functionality to the hardware [back]-key. This might be confusing to new users but better for users familiar with the Android paradigm. In FIG. 15 right hand side, when the user is dragging a widget the done button is replaced by a trashbin (see centre of bottom of screen). To remove a widget the user can drag the widget to the trashbin.

In FIG. 16 left hand side, the user has released the widget at a new position and the done button is presented again. Pressing the hardware [back]-button in this mode is the same as pressing done. It takes the user to the EPD pane in “normal” mode with the (new) widget(s) in place. In FIG. 16 right hand side, when the user has pressed “done” the new widget is placed. Longpressing a widget takes the user back to the edit mode with that widget currently selected.

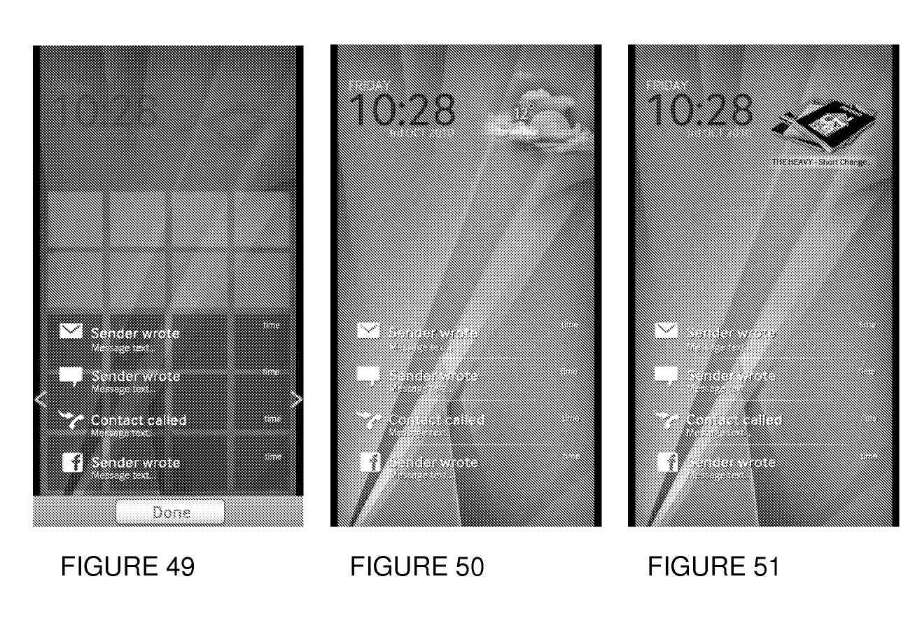

Examples relating to FIGS. 15 and 16 are shown in FIGS. 47 to 51.

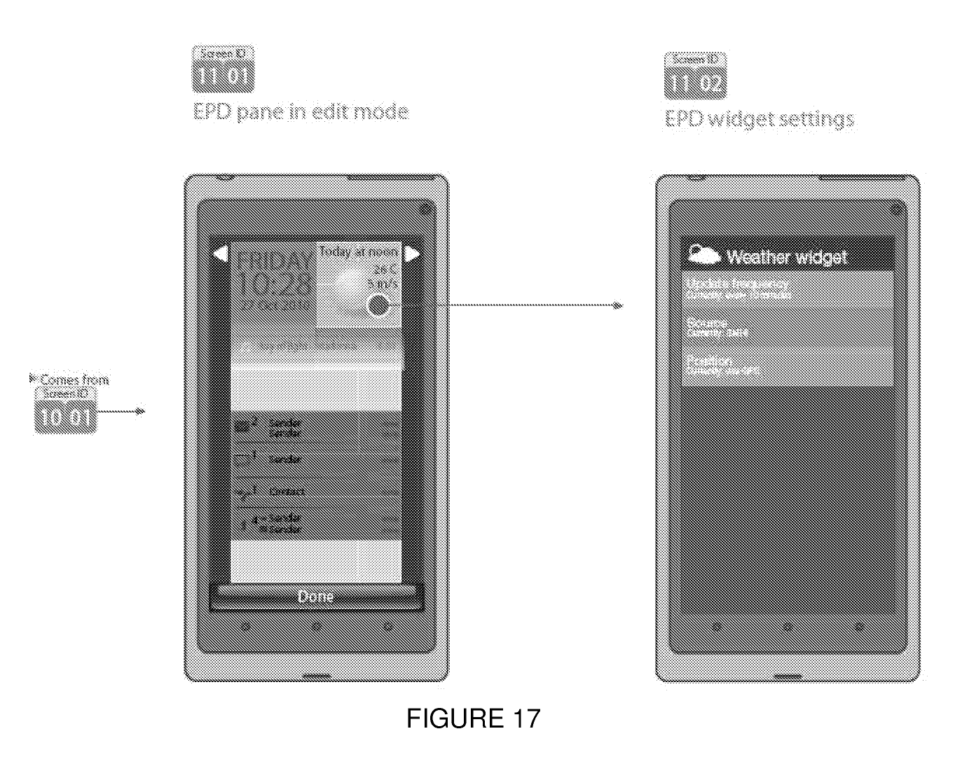

FIG. 17 relates to widget settings. In FIG. 17 left hand side, the user has tapped the weather widget in the edit mode and can now switch layout on the widget or move it around. Tapping the widget when it already is selected in edit mode opens its settings. There might be a need to communicate this more clearly by for instance placing a settings icon on top of the selected widget in edit mode. The purpose of having settings accessible through the edit mode is that this opens up for interacting with the widget by tapping on it in the “normal” mode. In FIG. 17 right hand side, when a widget is tapped in edit mode the settings for that widget are opened. All settings are saved as soon as the user makes them and pressing the hw [back]-key takes the user back to [1101].

Regarding configuring the EPD, this configuration solution differs a lot from the Android standard widget handling. This makes the EPD pane configuration stand out from configuration of the other Android widget panes. A general solution for all widget panes including the EPD pane is desirable. This is something that may be included for all widget panes. Even though this is currently a solution for only the EPD pane we still think that it is reasonable to include it here. Even though it stands out from the other panes there are some things to consider:
The whole EPD pane and its widgets already stand out from the rest of the Android panes in functionality. Differentiating the EPD pane to some degree might not be a bad thing.
The EPD pane is run as a separate application and the Android status bar is removed. This also already differentiates it from the other panes.

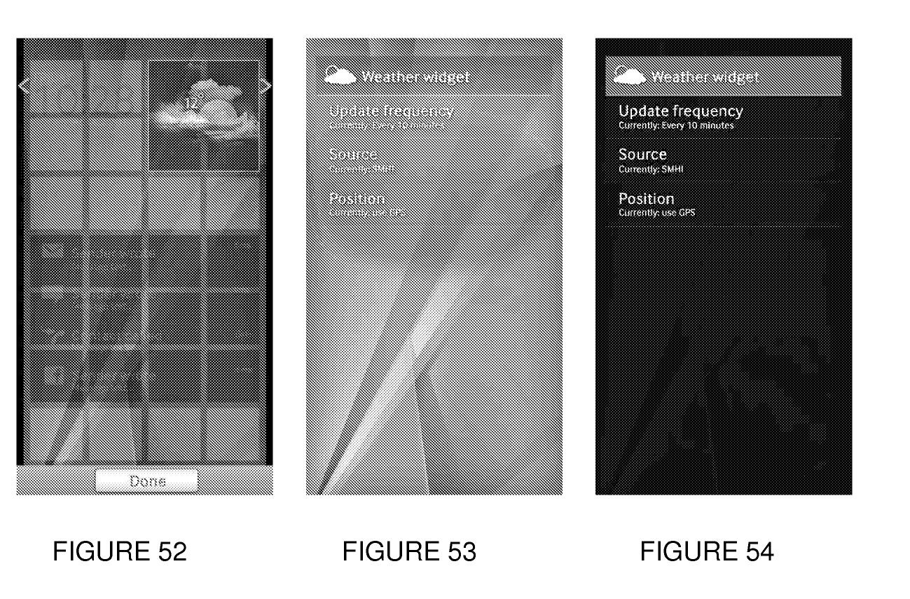

Examples relating to FIG. 17 are shown in FIGS. 52 to 54.

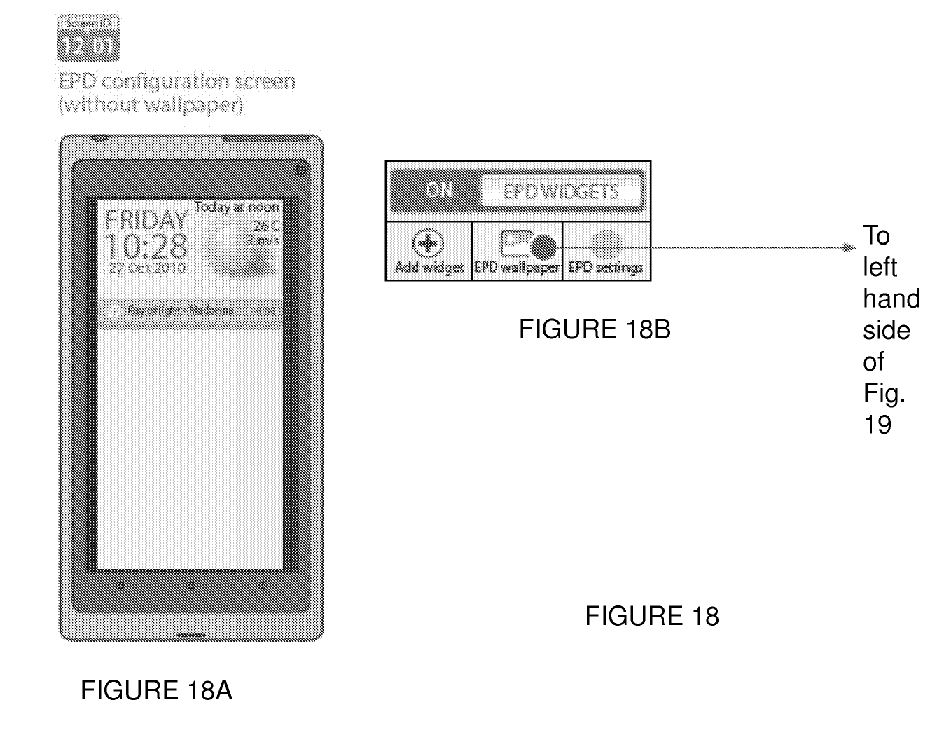

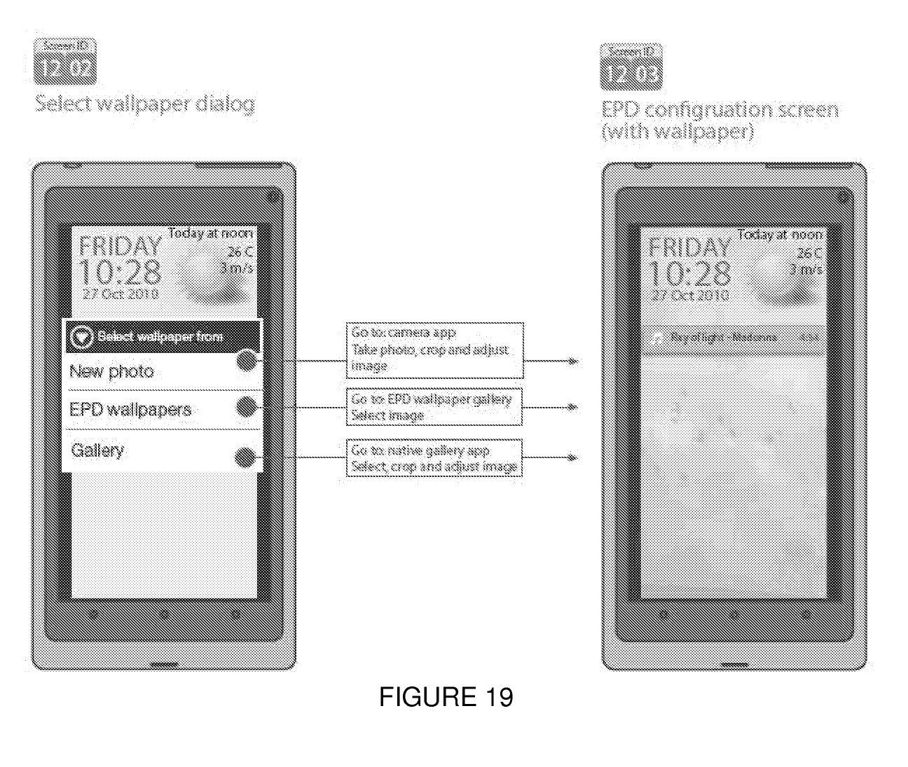

FIGS. 18 and 19 relate to setting wallpaper. In FIG. 18A, to set the wallpaper the user presses the [menu]-key to bring up the menu and then presses the EPD wallpaper option, as shown in FIG. 18B. In FIG. 19, when the wallpaper item has been selected in the options menu, this standard dialog that lets the user select the source of the wallpaper is opened. If the user takes a new photo or selects a photo from the gallery he is taken to a screen where he can crop and adjust the image. In FIG. 19, the user can select “New photo”, then Go to: camera app, Take photo, crop and adjust image. In FIG. 19, the user can select “EPD wallpapers” then Go to: EPD wallpaper gallery and Select image. In FIG. 19, the user can select “Gallery” then Go to: native gallery app, Select, crop and adjust image.

User Interface Interaction Design: Interacting with the Back Screen eg. the EPD Screen

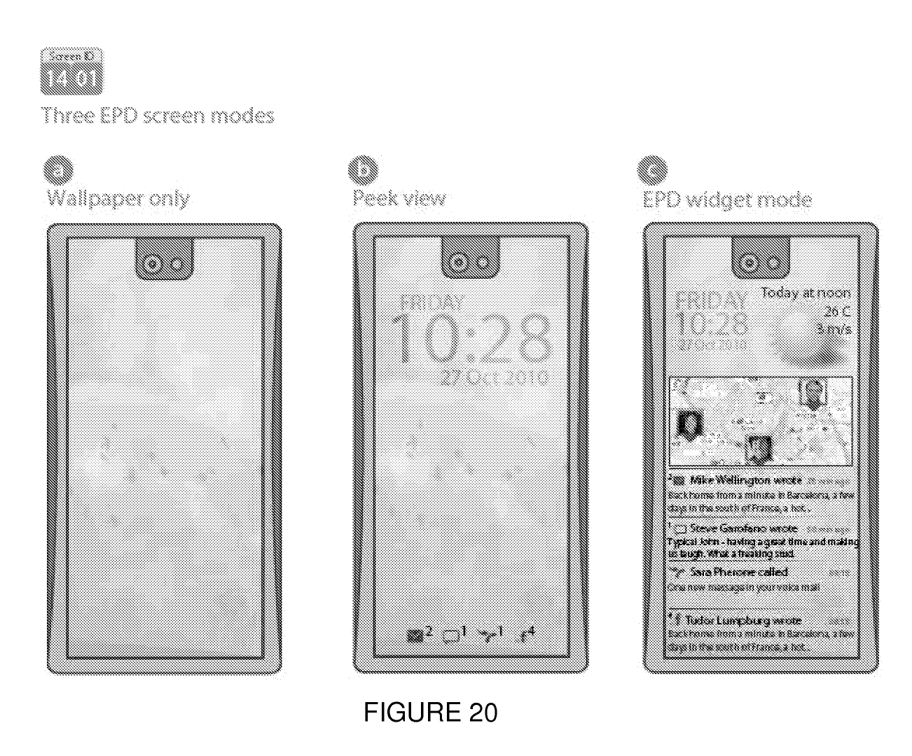

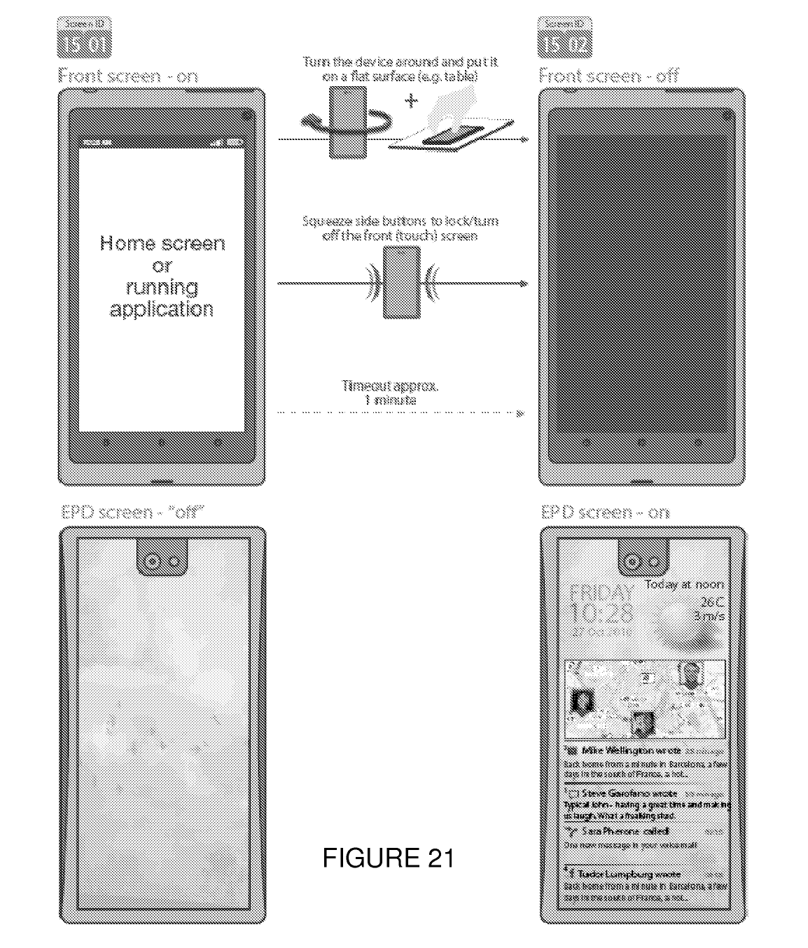

FIG. 20 relates to EPD screen modes. In FIG. 20 there are shown three modes that can be displayed on the EPD (apart from notifications). This is a summary of their content. How the user interacts with them is described below with respect to subsequent FIGS. 21 to 23. In (a), like the name implies, the wallpaper-only mode displays only the wallpaper. In (b), the peek view is a mode that displays only the wallpaper, a clock and a small notifications widget. The peek view is an intermediary state and is not customizable by the user. In (c), the EPD widget mode displays the wallpaper and the currently selected widgets. This mode is by default enabled but can be disabled by the EPD widgets on/off switch described above with respect to FIG. 9, or from other parts of the UI. When the user activates the PIN lock he is also prompted whether he would like to disable this mode or not.

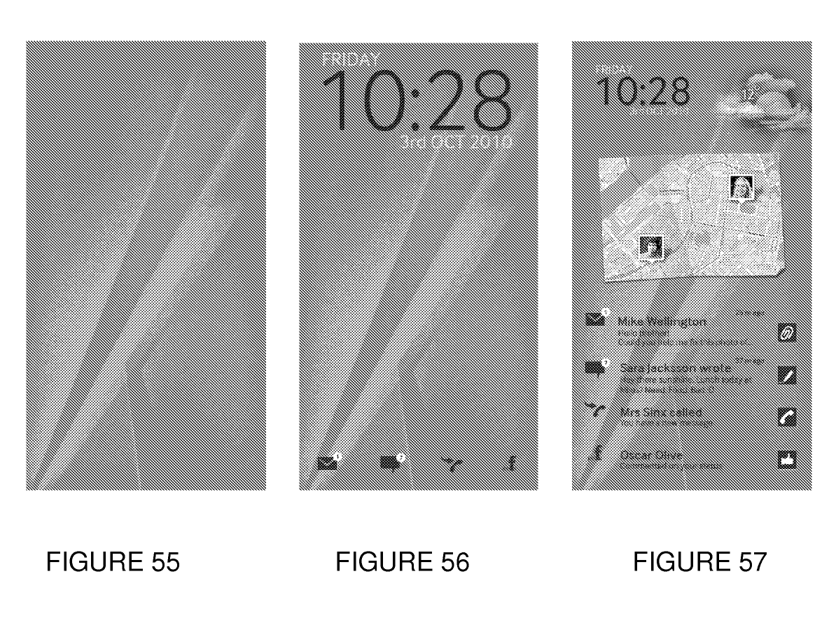

Examples relating to FIG. 20 are shown in FIGS. 55 to 57.

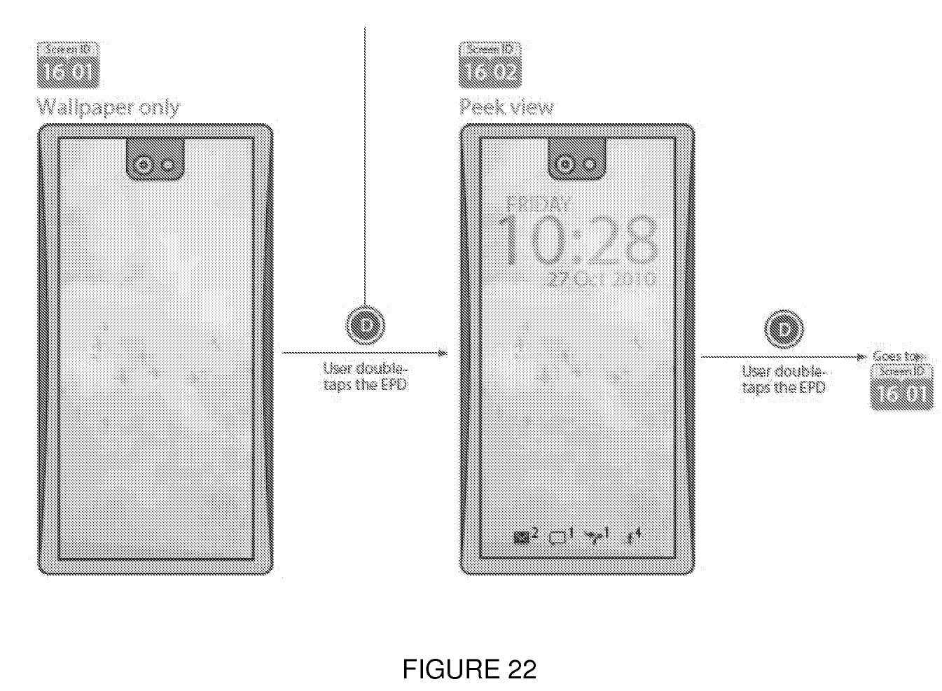

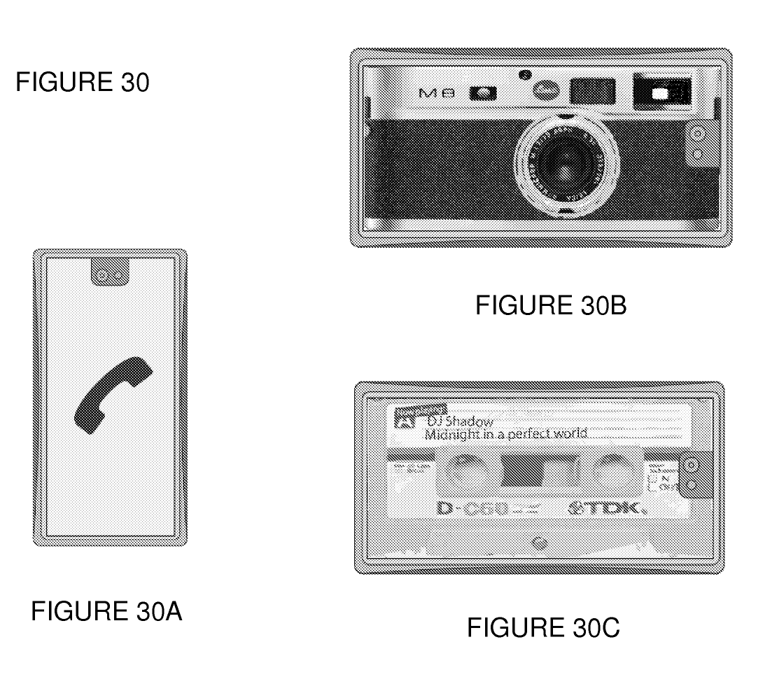

FIGS. 21 to 23 relate to interaction on the EPD screen. On the left hand side of FIG. 21, while the user is interacting with the front (touch) screen the EPD screen is kept clean (and private)—no EPD widgets are displayed. The only exceptions are some explicit applications that may control/utilize the EPD screen such as: Camera application, Music player, in-call (see FIG. 30 and related description). The left hand side of FIG. 21 shows the Front Screen On, Back Screen Off mode. This can be changed to the Front Screen Off, Back Screen On mode, as shown in FIG. 21. The device can be turned over so the back screen is visible with the device facing front screen on to a table or other flat surface, for example. Alternatively, side buttons can be squeezed to lock or turn off the front screen. A device timeout may be approximately one minute. The right hand side of FIG. 21 shows the Front Screen Off, Back Screen On mode. Once the user “turns off” the front (touch) screen, the EPD is enabled. Note: the behaviour of the default layout and interaction on the EPD screen is affected by settings performed by the user on the EPD configuration panel. For more information regarding the interaction (settings) on the EPD configuration panel, see FIGS. 7 and 8 and their accompanying description. For more information regarding supported interaction on the EPD screen, see FIGS. 22 to 26 and their accompanying description.

FIG. 22 shows an example of interaction on the EPD screen. In FIG. 22 left hand side, the user has turned the device front side down and since the EPD widgets are disabled (OFF) the wallpaper only mode is enabled as default. In FIG. 22 right hand side, the user has triggered the peek view mode and is presented with a clock and mini notification. The user may toggle between the wallpaper only and Peek view screens by double tapping the EPD screen. In FIG. 22, the scenario is that the user has turned off the front (touch) screen and turned the device front side down (ie backside upwards). The EPD widgets have been disabled (through the EPD pane settings). This scenario shows how the user easily can toggle between the wallpaper-only mode and the peek view mode.

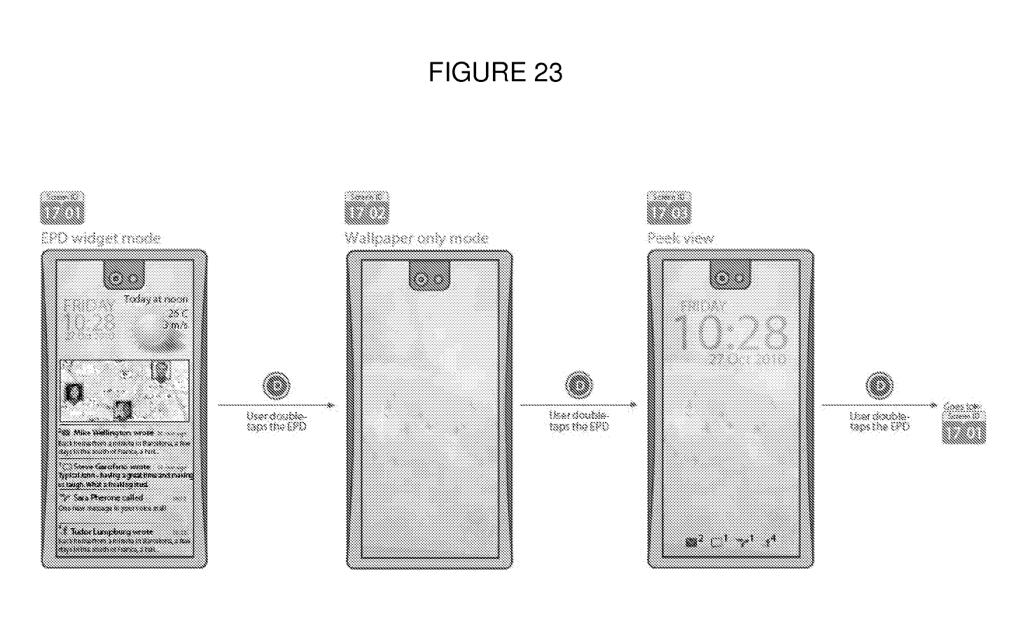

FIG. 23 shows an example of interaction on the EPD screen. In FIG. 23, left hand side, the user has turned the device front side down and is by default presented with the EPD widgets (since the EPD widgets are set to enabled (ON)). In FIG. 23, middle, the user has reached the wallpaper-only mode—all widgets have been turned off (but are still reachable). In FIG. 23, right hand side, the user has triggered the peek view mode and is presented with a clock and a mini notification. In FIG. 23, the user may cycle between the EPD widget mode, the wallpaper-only mode, and the Peek view mode screens by double tapping the EPD screen. In FIG. 23, the scenario is that the user has turned off the front (touch) screen and turned the device front side down. The EPD widgets have been enabled (through the EPD pane settings). This scenario shows how the user easily can cycle between the three EPD states without having to enter the Android experience (EPD pane).

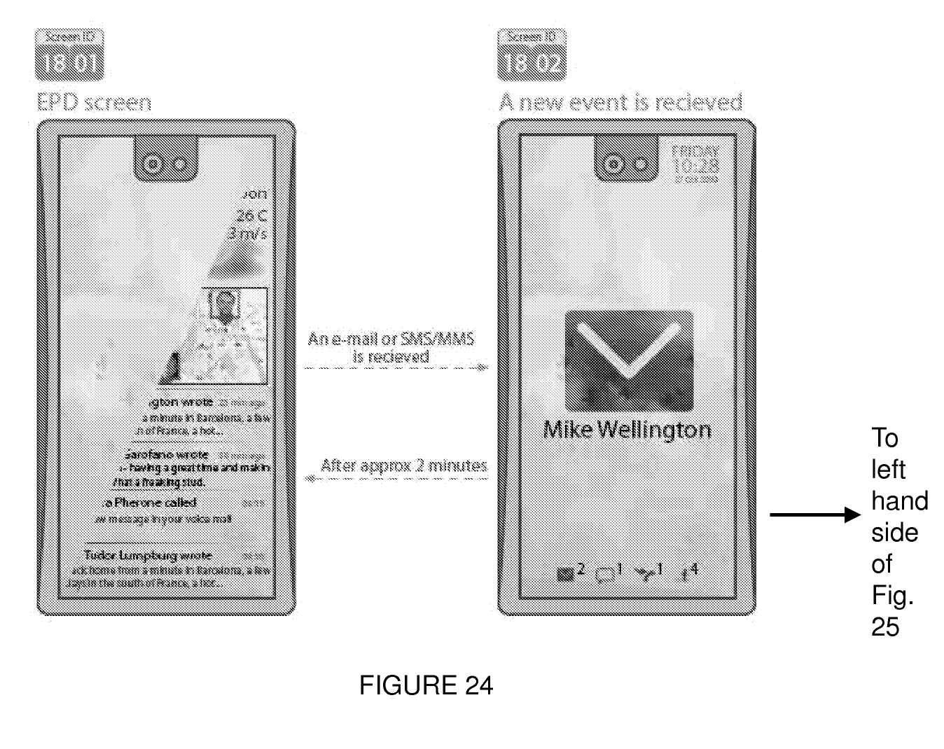

FIGS. 24 to 26 relate to incoming event notification. The scenario of FIGS. 24 to 26 shows how the user is able to interact with incoming messages. It also shows how notifications could coexist/interact with the front (touch) screen.

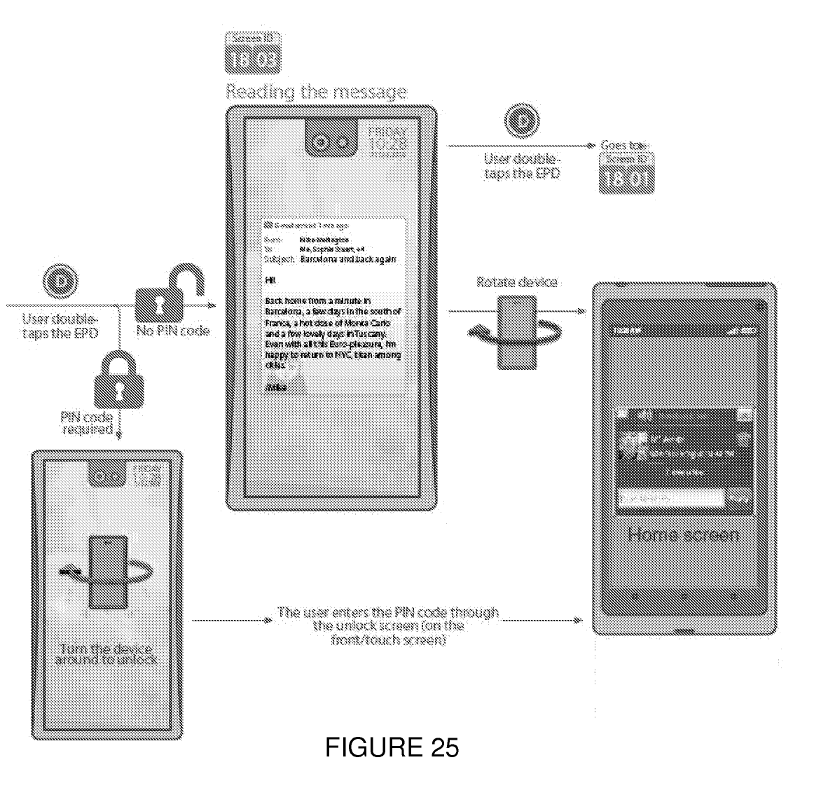

In FIG. 24 left hand side, the user has switched off the front (touch) screen and the EPD screen is activated. The user is either presented with the EPD widgets enabled or disabled depending on current EPD pane settings. In FIG. 24 right hand side, when a new event (eg. message: E-mail, SMS/MMS, facebook) occurs a notification indicator is displayed eg. for approx. 2 minutes and then returns the screen to its previous state. While on the screen, the notification takes over the EPD screen real-estate. The next step is shown on the left hand side of FIG. 25.

Continuing on the left hand side of FIG. 25, the user may progress by double tapping the EPD. If a PIN code is required, the device must be unlocked, eg. by turning the device around or turning the device over to execute an unlock process. The user may enter the PIN code through the unlock screen (on the front/touch screen). After entering the PIN code, if the user would flip the device to the “Touch screen” in this state—the user would be transported directly to the current message/event (native application) and be able to instantly act on the event (read/answer/consume).

If no PIN code is required, the user may read the message. The user is presented with a large portion of the actual message. If the user turns the device over to the front screen, then the user would be transported directly to the current message/event (native application) and be able to instantly act on the event (read/answer/consume).

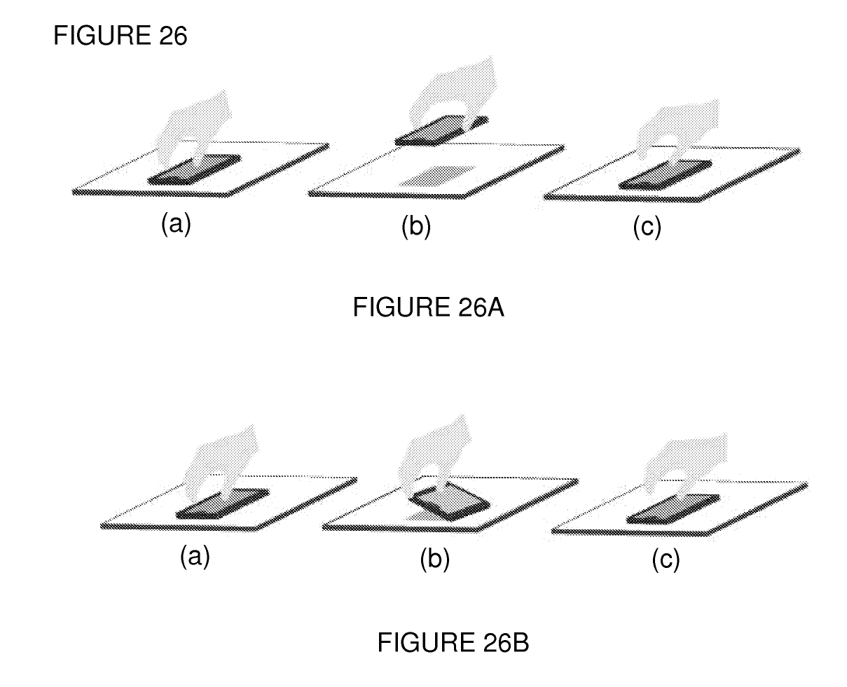

FIG. 26 shows two possibilities for dismissing an event notification. In FIG. 26A, in (a) the user grabs the phone; in (b) the user lifts up the phone; in (c) the user gently lets it go to return it to its initial position—now the event notification has been removed from the screen and the EPD screen is returned to its previous state. In FIG. 26B, in (a) the user grabs the phone; in (b) the user lifts up the side; in (c) the user gently lets it go to return it to its initial position—now the event has been removed from the EPD screen.

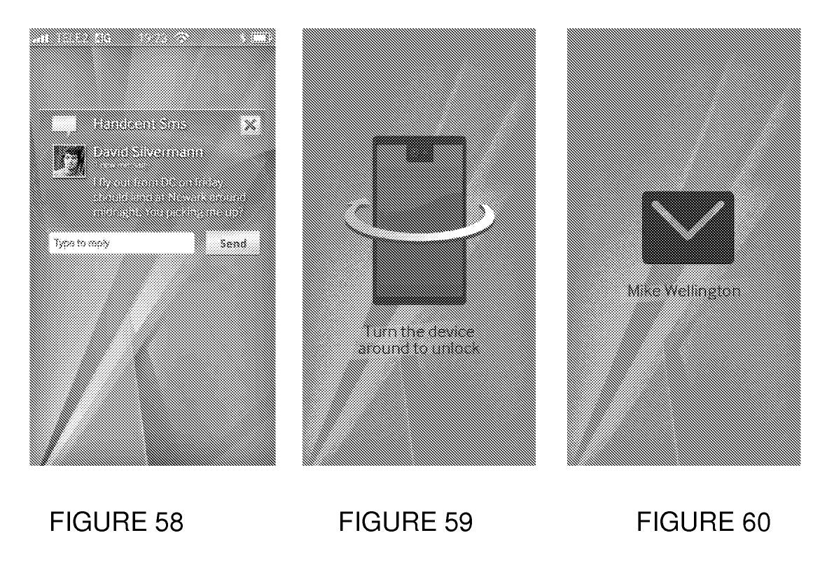

Examples relating to FIGS. 24 to 26 are shown in FIGS. 58 to 60. FIGS. 58 and 60 are examples of screens corresponding to new events. FIG. 59 is an example of a displayed screen if an unlock code is required.

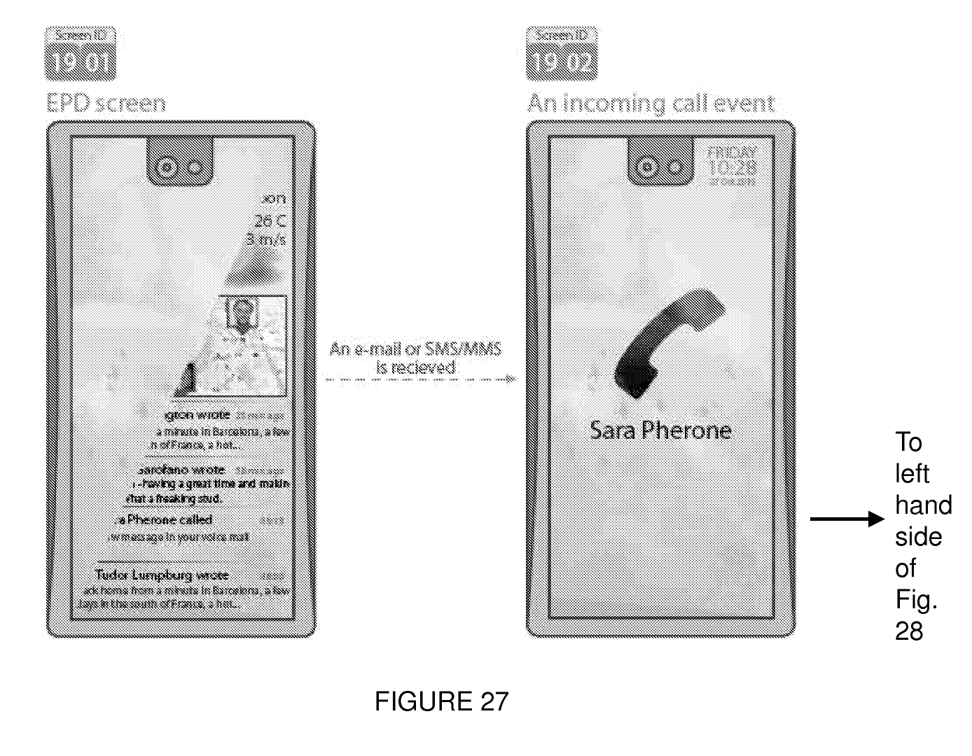

FIGS. 27 to 29 relate to an incoming call. The scenario of FIGS. 27 to 29 shows how the user is able to interact with incoming calls if the PIN lock is enabled or if it is disabled. It also shows how an incoming call coexists/interacts with the front (touch) screen.

In FIG. 27, left hand side, the user has switched off the front (touch) screen and the EPD screen is activated. The user is either presented with the EPD widgets enabled or disabled depending on previous state. In FIG. 27, right hand side, when the user receives an incoming call (eg. skype or other voice service) the event takes over the entire EPD screen real-estate. No interaction is supported during an incoming call event. The front (touch) screen is turned on simultaneously and shows the [1903] screen. Interaction on the front screen is not supported until the device has been turned around or turned over.

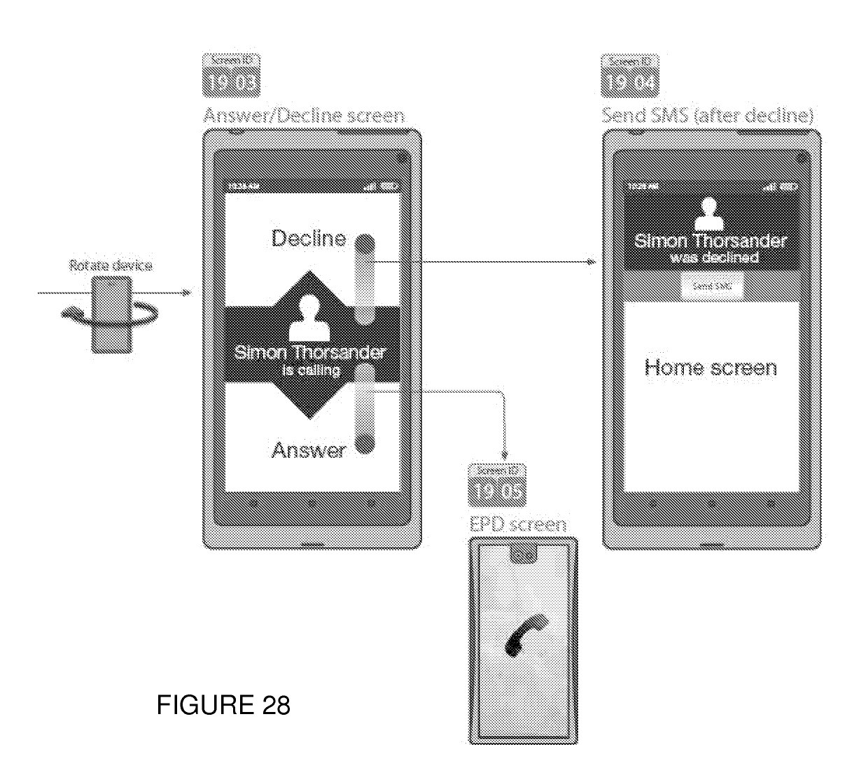

In FIG. 28, left hand side, the front screen shows the incoming call dialogue. The user swipes up to answer, or swipes down to decline and go to the homescreen. In this scenario the front screen is unlocked; if it were locked while receiving the call this screen would show in just the same way. Pressing the [menu]-button would allow the user to “Mute”, “Decline & Send SMS”. “Decline & Send SMS” would require the user to unlock the phone if PIN code is enabled before reaching the “Send message” screen. If an answer is performed, we move to the EPD screen: while in-call the EPD shows an “in call” icon.

If a Decline is performed, we move to the right hand side of FIG. 28. If the user activates the “Decline” command the area will slide into the above layout—allowing the user to “Send a message” to the caller. The “overlay” area would stay visible for approximately 5 seconds and then disappear. The user could also tap on the underlying screen (in this case “Home screen”) and thereby dismiss the overlay. The overlay is also automatically removed after a short period of time.

If the device is PIN locked, then the user would be provided with the unlock screen instead.

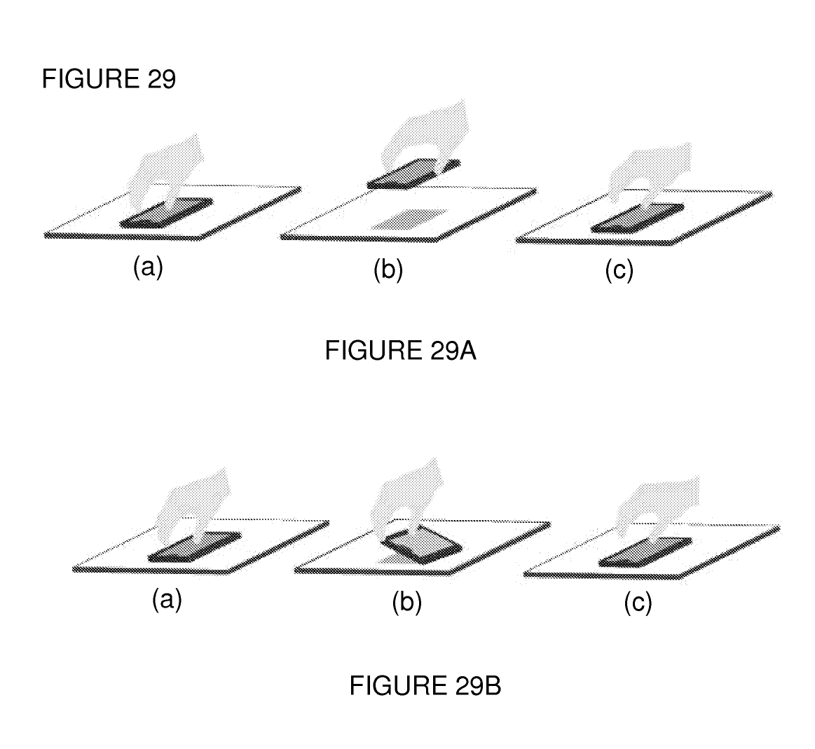

FIG. 29 shows two possibilities for muting an incoming call. In FIG. 29A, in (a) the user grabs the phone; in (b) the user lifts up the phone; in (c) the user gently lets it go to return it to its initial position—now the call has been muted. In FIG. 26B, in (a) the user grabs the phone; in (b) the user lifts up the side; in (c) the user gently lets it go to return it to its initial position—now the call has been muted.

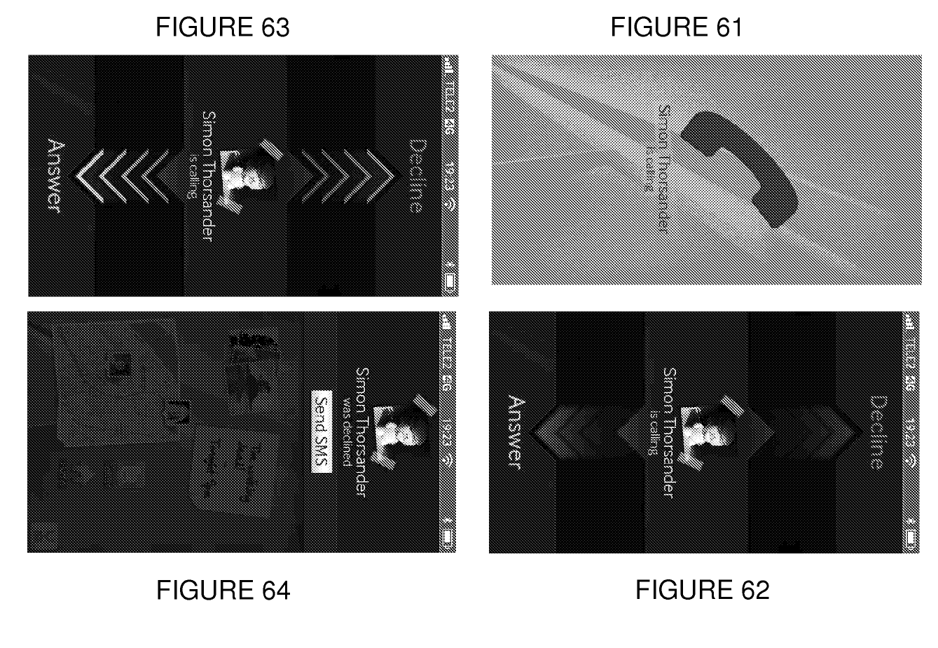

Examples relating to FIGS. 27 to 29 are shown in FIGS. 61 to 64.

### User Interface Interaction Design: Back Screen Use Cases

FIG. 30 relates to back screen use cases.

FIG. 30A relates to an outgoing call. During an incoming call a simple telephone icon is displayed on top of the wallpaper on the EPD. Not so much to show others, most parts of the phone would probably be blocked by the hand anyway. An example of a scenario when this would be useful would be if the user forgets to hang up a call, then both the front and the back of the phone will alert him that he is actually still having an active call.

FIG. 30B relates to a camera function. From the front screen the user can easily choose one from a few camera skins that will cover the back screen while using the camera application. The skins could, like in this example, be stylized images of vintage cameras, much like the hipstamatic interface. The style of the skin could also be applied to the front screen UI to give the user a comprehensive and appealing experience.

FIG. 30C relates to a media player. In this scenario the user is using the media player listening to music. Displayed on the back screen is a skin and also information about the current track blended together. Apart from a cassette, a media player back screen skin could also for example be an image of the currently playing albums cover. Much like the camera these skins should be optional and easily customizable. The skins should also only be visible when the user has the actual application open. In this case this skin would not show if the user had the media player only running in the background playing music.

### Gestures Lock

There is provided a device, such as a communications device, such as a mobile communications device. Examples of mobile communications devices include mobile phones, smart phones, tablet computers, and laptop computers with a mobile communications capability.

Main idea here is new gestures to unlock and lock the screen of touch screen mobile communications device (eg. a phone). In short terms—it's a replacement for switching the screen on your iPhone on with button on upper side of the device and a replacement for the unlock gesture at your iPhone at the same time.

### Implementation Details:

When mobile communications device (eg. a phone) is in standby mode (display is off) touch screen remains on:
User swipes screen from bottom to upper area to switch mobile communications device (eg. a phone) to operational mode (eg. to unlock)
(optional) we can add power on animation—as long user swipes the finger actual display image appears under the finger.

When mobile communications device (eg. a phone) is in operational mode:
User swipes screen from upper part to the bottom area to switch mobile communications device (eg. a phone) to standby mode (eg. to lock)
(optional) to avoid interference with OS control elements we can add additional touch area above the main display

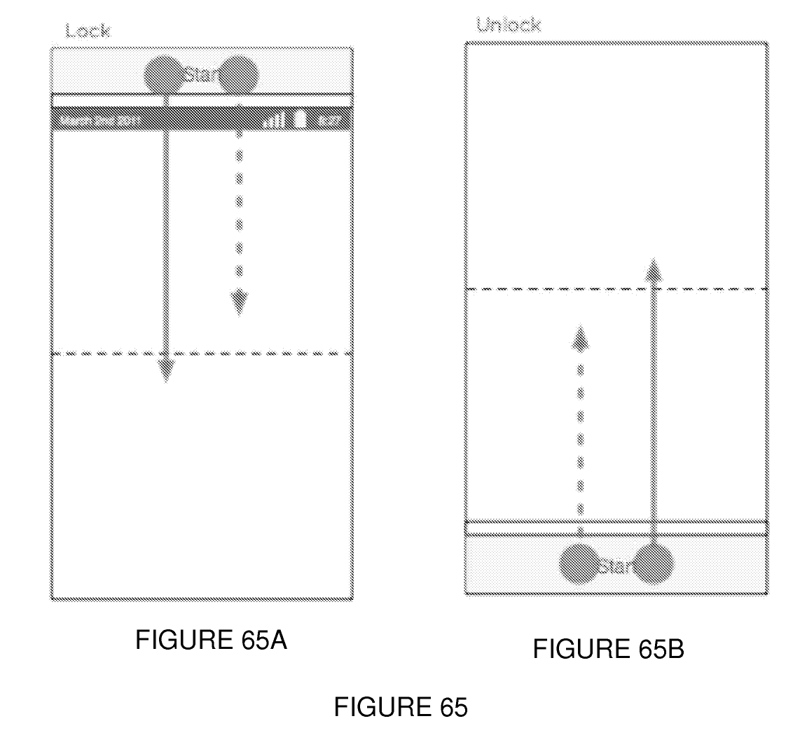

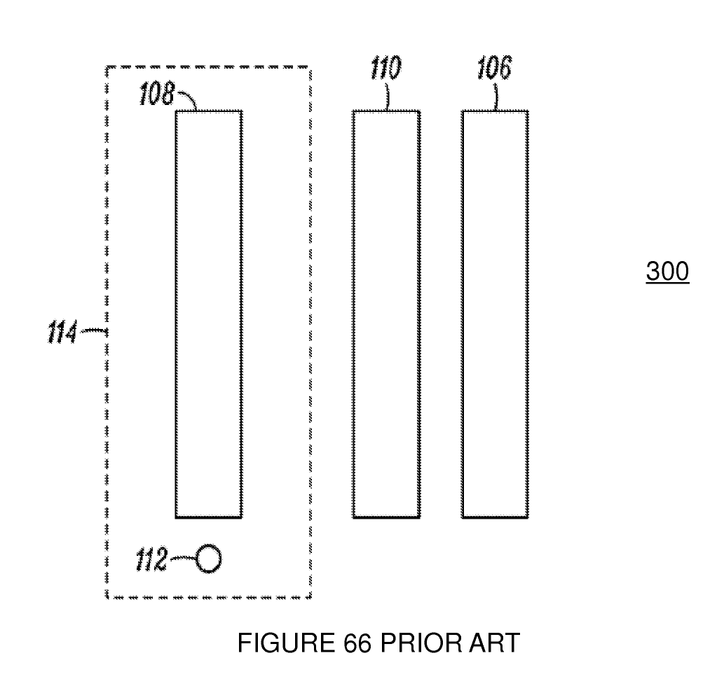

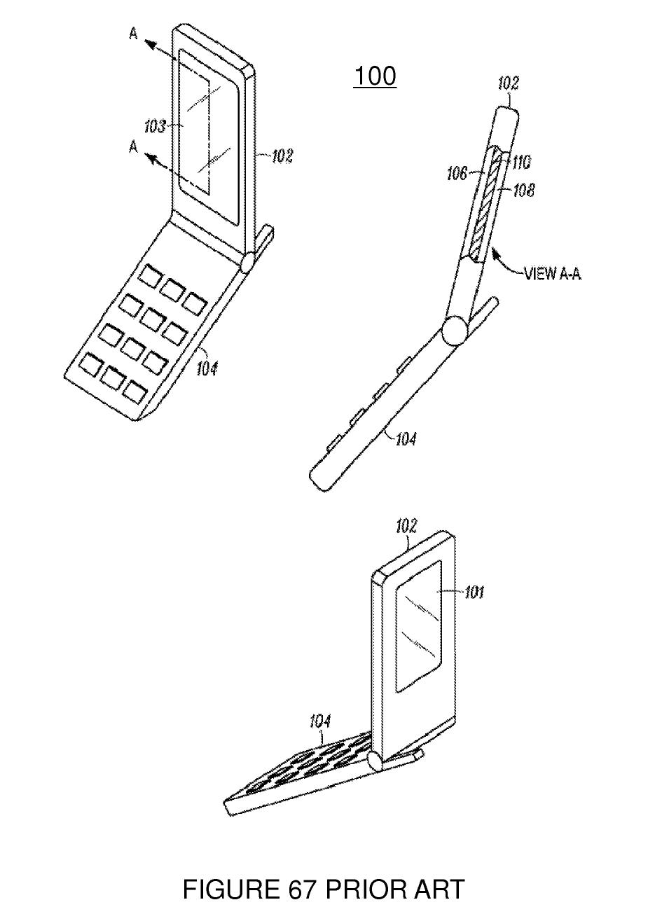

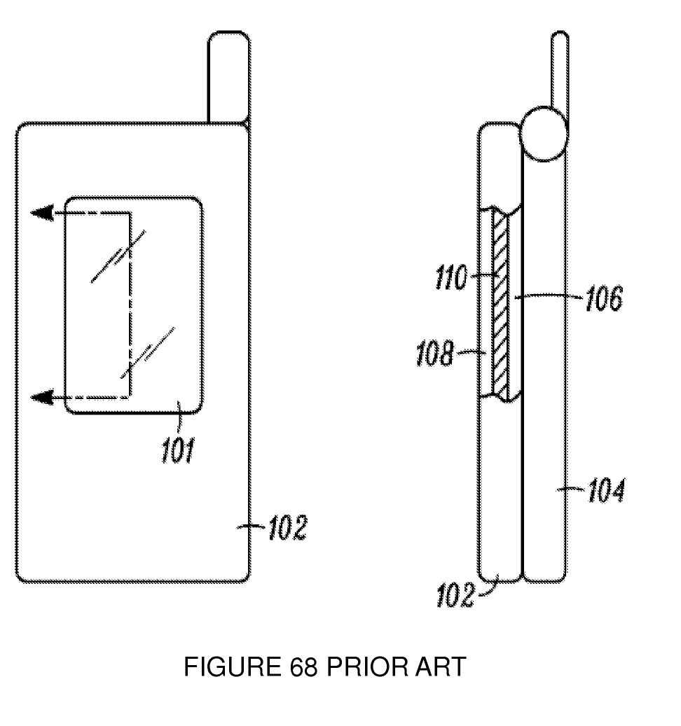

An example is shown in FIG. 65. FIG. 65A illustrates a pan gesture suitable for locking a device screen. In an example, panning top-down locks the screen. When a cut off point of 50% down the screen is reached, the screen is locked. A swipe gesture does not need to be as long as the pan gesture if the swipe speed is enough to take the screen over the lock border. There may be a non-active area between the top capacitive area and the screen edge to separate lock gesture from status menu gesture.

FIG. 65B illustrates a pan gesture suitable for unlocking a device screen. In an example, panning bottom-up unlocks the screen. When a cut off point of 50% up the screen is reached, the screen is unlocked. A swipe gesture does not need to be as long as the pan gesture if the swipe speed is enough to take the screen over the lock border.

### Key Technical Aspects of the Device, UI and Interaction

This section describes key technical aspects of the device, UI and interaction, which are assessed on feasibility and issues. Here we go into specific topics. This section is divided into topics. Each topic will be lead by a story, state the scope of assessment and followed by the assessments.

### Device

The device is intended as an always connected device with next generation technology.

### Technical Specifications:

### Qualcomm Snapdragon (MSM8260)

Dual-core 1.2 GHz
Adreno 220

### NXT/NISSHA—Main Screen Solution

WVGA+ (480×800-854)
Bending wave multi touch input
High resolution multi touch haptic feedback
Flat loudspeaker surface

### EPD—Electronic Ink Display on Back of the Device

### Sensors

Accelerometer+Gyro
Analogue pressure on sides (Squeeze)
Light meter
Proximity
Thermometer
Camera
1-3 Capacitive buttons in the front, below front screen
Volume buttons on the side.

### Operating System

Android 3.0/(post-Gingerbread)

### Concept

This is a Dual screen device with an EPD surface covering almost entire back side of the device, differentiating it from other devices. There are currently some gestures involved in making the dual screen experience unique.

### Scope

The user may be able to interact with the back screen. Gestures are feasible and can be accurately detected. Determine what screen the user is viewing. Sensors are needed and their physical placement should be suitable.

Interaction is an important issue for the back screen. Some interaction is allowed. This is motivated both from a power consumption point of view and user experience and expectation, e.g. acquire information without having to turn on the main screen, quick gesture to switch between the amounts of information displayed etc.

Gestures should be simple and easy to detect. Gestures should not be used to initiate interaction, which would require constantly running sensors and central processing unit (CPU). The sensors should be turned off when the phone is locked and idling, and the CPU not constantly processing the signal to detect an incoming gesture.

With the information available currently, we discourage gestures like “tapping on the device”, mainly due to power consumption (motivated further under the ‘Power consumption’ topic below), but also accurate gesture recognition under the different positions of the phone. We expect the tap to be sensed differently if the phone is on different surfaces or in the user's hand or if tapped with your thumb of the same hand or with the other hand.

A vital aspect of dual screens is to determine what the user is looking at, especially if the user can interact with both screens. User input might become ambiguous and disrupt the user experience. Utilizing sensors may solve the issue to some extent or completely, depending on their placement, specifications and reliability.

Currently, the best functioning initial interaction seems to be the pressure sensors or the volume buttons. The issue to solve here is other interactions designated to these sensors. The applied pressure on squeeze sensors, if reliable enough, may be used to solve the ambiguity issue above. Pressure sensors are known from eg. US2011/0038114A1.

From a power consumption point of view, it is highly justified to momentarily use even several sensors for detecting gestures that might save the user from turning on the main screen. However, these gestures should be reserved to user reaction only. For example, if the phone is laying upside-down on a table and there is an incoming call, we can turn on several sensors to determine user response, like dismissing the call if user lifts one side of the phone and let go again. The light, proximity, accelerometer and gyro sensors might be used in some combination to accurately identify this gesture. (This particular example required a table).

Another gesture in the concept has been to be able to turn the device from the EPD, displaying a message preview, to the main screen, which instantly shows the full message with option to reply etc. It is tricky to make this work, but may be possible using the gyro in most situations. Lock screen interaction should also be considered in this interaction.

For touch gestures on the main screen, e.g. 2-finger swipe to access EPD configuration screen, we see no apparent complications or feasibility issues as long as they are performed from Yota Home or other Yota controlled applications, as they can be designed for possible incoming gestures.

Global gestures are assessed to be unfeasible in implementing and maintaining as they would require significant work and modification to Android and/or touch drivers. These might also become an annoyance to the user or block proper usage of applications. Complicated gestures, especially if not well designed for the specific application running, might also become a performance or response issue.

### EPD (Back Screen)

The device will have an EPD surface covering almost entire back side of the device. EPD display is meant to be always on. It is said to have better refresh/update rate than previous generations. It will be rendered in portrait mode only. EPD display will only accommodate specialized widgets or application, i.e. no third party allowed. Electronic ink displays typically have very low power consumption.

### Scope

Keep the EPD interface within the limits of the hardware. The screen may be protected from third parties while still allowing application context. Main screen UI may be communicated with for daily usage and configuration.

### Assessment

With low refresh rates, we should not use any animations, but “living wallpaper” with slow animations (eg. over a day) may be feasible. Partial updates on EPD displays leave shadows and artifacts; full refreshes are usually needed every now and then, but can be tactically minimized if design and interaction permits.

EPD process could run under Yota Home, but it is recommended to have it as a separate activity or service and allow communication with selected applications (e.g. Home, Lock Screen, Phone etc.) through some (undisclosed) application programming interface (API) for context changing and configuration. Having separate activity or service for EPD would also allow it to successfully sleep while the other applications are on top or always run in the background. Currently, a service seems most logical implementation and should avoid eventual window stack and Android issues with dual screen. (See also ‘Android’ assessment about dual screen below).

Current UI design of the EPD display includes some user interaction even when the device is locked. Interaction should be possible through customization of the Android lock screen activity or “key guard” while the device is locked. (Customizing the lock screen also enables style unification across the most basic parts of the UI and help creating the brand).

Yota Home can be used to configure the EPD and communicate the user preferences to the EPD service. EPD service can also be enabled to communicate back to Yota Home for use cases such as going directly to message, if previewed on EPD. Other chosen application may also be allowed to communicate to EPD service for special use cases, e.g. Camera application telling EPD to draw a picture of a camera on the back surface.

Initiating interaction with the EPD UI should be via hard keys or similar. Reacting on events could use more complicated gestures. These are motivated in ‘Concept’ above and ‘Power consumption’ assessment below.

### Dynamic Profiles

Yota imagines various phone settings changing and events happening automatically with change in context, for example, hidden widgets appearing at certain times or themes changing with the weather.

### Scope

Consider intelligent profiles, automatically and dynamically changing to suit the user's environment. Context (location, time and other sensors or user input) may affect the style and layout of the UI, including for example widgets (and information) on front and back screen. Text style may be changed for readability, depending on the background.

### Assessment

Depending on the scope of automatization, artificial intelligence may be used to determine correct context. More feasible/less work is to define some simple contexts, which, together with some user input and various sensors, can switch between some predetermined “profiles”.

Profile changes should not be so frequent or such that they require special sensors running most of the time. Although, for slow or infrequent changes, sensor may well be used to poll the status, e.g. once every day check the temperature at a specific time to guess the season or the GPS every hour to see if the user changes location or even in combination for best guess. See also ‘Power consumption’ assessment on sensor usage below.

Changing the UI style depending on the properties of the background imagery currently chosen by the user is complicated and costly, especially for Live Wallpapers. Even static wallpapers are complicated as they may include very bright and very dark regions, and with added parallax this also becomes unfeasible. It is recommended to use background for any text used on the main screen. The EPD escapes some of these issues. Here, the static backgrounds can either be chosen carefully or assessed runtime to choose best brightness of text. There are still issues with local variances in brightness for custom wallpapers and changes in EPD-“Living Wallpapers” and it is recommended to use text background here too for any fine text.

### TAT Home

TAT Home is a complete Android home screen solution built on TAT Cascades. TAT Home supports Live Wallpapers, Live Folders and Android widgets. Moreover it allows specialized TAT Widgets controlled and rendered via TAT technology. TAT Home is extremely customizable, both visually and functionality-wise.

### Scope

Assess TAT Home as Yota Home.

### Assessment

TAT Home is very versatile and customizable in most areas. It incorporates scheme for Yota specialized widgets, both if Yota wishes to utilize TAT graphics engine to the full extent or via Android widgets. TAT Home can be partially or fully customized in functionality, layout and style for desktop, application list/view, widget handling, overview etc.

TAT Home can communicate with the EPD service to setup the layout and controls through a special configuration screen and also actively and continuously control its context. TAT Home also has a silent update scheme through Android market already in place and tested.

### Android

The device will run a version of Google Android OS (possibly 3.0—post Gingerbread). All the features of Yota customization should be cost efficient and need to be compatible, easily maintainable and quick to merge with Android updates.

### Scope

Assess Android compliance of concept and design. Assess the feasibility of changing styles to Android applications.

### Assessment

Google has an extensive test suite for Android devices for eligibility for Google market. These need to pass in order to have access to the market. The critical changes relevant to Yota would be Android style changes and lock screen modifications needed for the concept and design.

Another critical issue is the dual screen support on Android. Although, if the EPD runs as a service, and is the only one allowed direct access to the back screen, the device could technically be seen as single screen device; EPD service application programming interface (API) would be the only way to access the “screen”. Implementing this way will save a lot of cost in implementation and avoid Android dual screen issues.

Android themes and styles are described in markup language (XML) and should be low cost to modify and presumably same to maintain for the foreseeable future.

These styles are hierarchical and can be overridden fully or partially by an application for its visualization. Changing native base styles could have unintended visual effects on third party applications (that assume a specific default style, e.g. background colour), especially if they inherit and mix with their own styles. Changing styles for specific applications, such as Phone application, status bar etc., should avoid third party style issues in all or most cases. This is where we recommend any needed style changes be done.

Installing additional system wide fonts is fairly easy, and can be assigned to standard Android applications through the same XML as above.

Icons should be easy to replace from a technical point of view, especially if they keep the original form factor, but the amount of icons might present some graphics work. A quick digging in Android source revealed about 140 icons and images related to the status bar. Of the icons, normally about 10-20 different are shown to an average user. However, some of these icons do have several states or animations, e.g. different battery levels or WiFi signal strength, where each of these are separate icons. Each state is of course only a minor modification to basically the same icon base.

Market applications are also recommended to produce the icon sets in three resolutions to fit the different supported screen densities, but this should not be an immediate concern of Yota as the screen resolution is fixed. Also, per Google's guidelines, these can be scaled versions of the original medium sized set.

### Power Consumption

Being an always on and connected device and a social center with lots of innovative features the battery time could become an issue.

### Scope

Assess power consumption when designing the UI and interaction. Share ideas on how to best save power. The sensors may be used, if needed for UI and interaction.

### Assessment

The biggest culprit in power consumption today for the average user is by far the liquid crystal display (LCD) and its back light, followed by what is drawn on the screen and various networking devices. While the dual screen concept may reduce the main screen power consumption, TAT technology can minimize the amount of pixels needed redrawing by keeping track of changes to the UI elements and only updating the “dirty rectangles” (reference may be had to Appendix 3).

EPD is always on and, depending on its power efficiency, should be updated as little as possible. But, using it, instead of forcing user to turn on the main LCD screen, where possible, might help save more power in the long run. Rendering EPD with TAT technology could provide additional power saving through the “dirty rectangles” feature. Although, if the EPD is its own application or service, it would require a separate TAT graphics engine running. This may depend on the exact usage of the EPD.

Features that require sensors to be constantly running should be avoided, e.g. tap as initial gesture to interact with the device would require the accelerometer (or another sensor(s)) to be always on. Unless this sensor is extremely power efficient, the battery drainage over a day could be substantial. CPU would also be required for sensor signal processing and gesture recognition (the more advanced the gesture, the more CPU power is required), not to mention the effects of possible false positives. Current assessment is that hard keys be used for initiating interaction.

Going into details, it is our understanding that current generation gyro+accelerometer sensors use about 20 times less power than the backlight of a LCD screen. If this (plus CPU usage) can be worked into the battery budget, above scenario could be feasible.

On the other hand, solutions using EPD and turning on some sensors for a short duration for an incoming notification or events that the user can react on without having to turn on the main screen could help save a lot of power. This is a strong motivation for the EPD interface having some interaction.

A general rule is to use more power to shorten the processing time than to use less power for longer periods. This applies to all hardware; including sensors etc. and becomes very significant with network devices and communication. To conserve power, one should use the fastest connection possible (e.g. WiFi) than use slower but lower power consuming connection (2G/3G) over a longer period of time. Grouping downloads, updates and other network access together, instead of random accesses, is also an example.

### Performance

Performance is prioritized over features and effects. UI should keep stable frame rate as far as possible.

### Scope

Find the best applications for and utilizations of Dual-core. Investigate frame rate locking; we may stabilize the frame rate to some specific number. Provide guide in best usage of TAT Cascades (e.g. asynchronous data services).

### Assessment

Android specifications for dual-core support must forego any thorough technical assessment for utilization of dual-core processors. Generally, it is possible to delegate asynchronous tasks to different cores for simultaneous processing, even though it might be tricky. The operating system might handle this or an application with a sub-task might be allowed to run it on the core of its choosing. TAT Home itself does not use this feature, but network services or decoders providing data or images to TAT Home could then run on a separate core to avoid blocking the UI and keeping it responsive. Wait and see how to use the dual core until after Android Gingerbread support is known.

It is impossible to guarantee a specific frame rate over any specific number under all circumstances, but a lot of measures can be taken to deliver a stable and smooth UI experience. Choosing correct rendering methods, integration method, application schemes etc. for your specific UI are vital.

TAT Cascades is heavily optimized for fast rendering, but care must be taken when developing services for it. For example, it is vital that a service providing data to be quick at its task, so it does not stall the UI. Sometimes a service will need to process heavy and time consuming tasks. In these situations, considering an asynchronous scheme might be a better idea. Typical situation are image decoding and accessing network data. Further reading on different optimization areas and full documentation and examples are available from TAT developer site accessible to customers developing with TAT products after a signed TEA.

Using OpenGL acceleration in most cases boosts the performance considerably. TAT also has a performance test tool that is run on devices to find their base characteristics, e.g. memory bandwidth, GPU features and performance etc. Through this, we can quickly find a lot of pros and cons of a device and are able to avoid the bottlenecks.

The cost in power consumption is very hard to assess without tests on the target with the intended UI. Following the general rule in ‘Power consumption’ above, it is better to render as quickly as possible, even if using a high amount of power, and then idle until next frame than to constantly use lesser amount of power all the time. The former case might be easier to achieve with graphics acceleration and using frame rate capping, whereas the latter could easily turn out to be the case for software rendering, depending on the specific UI and effects, but of course needs to be tested. Furthermore, it is plausible even that real-world tests show less instantaneous power consumption when using hardware acceleration than rendering in software. These things are often not of concern, unless we are pushing to the limit, as the power consumption of CPU and graphics processing unit (GPU) are much lower than the back light of the LCD, which would of course be on if we are rendering to the main screen.

### Updates

### Scope

The update process will work. Investigate silent updates.

### Silent Update

Android Marketplace accommodates silent updates (apart from currently suffering first time update issue with preinstalled applications). Applications on Android market can be viewed from and downloaded by anyone. Measures can be taken to prevent installation on unintended devices. TAT Home already utilized this mechanism.

A custom solution may be deployed for all or part of the update process as well, but initial work and maintenance will increase significantly.

EPD being a separate activity or service would require its own update process. Whether it is through firmware, custom solution or Android market, may depend on its integration on Android. If the EPD is part of Yota Home, they would naturally share the update scheme.

### Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

### Concepts

This document includes multiple concepts. Some concepts are summarized below.

1. A Mobile Device with Two Screens: One Main Display and One EPD Display
Joker is a ‘Dual-Side’ device—i.e. a slate format mobile telephone with a LCD touchscreen on one side and a touchscreen bi-stable EPD surface covering almost the entire read side of the device.
The device should allow interaction with sensors when the main screen is turned off. For example to acquire information on the EPD screen.
   This can be achieved via using extremely power efficient sensors.
   This can also be achieved through turning on the sensors and thus allowing interaction, when a specific event occurs, such as a notification being displayed on the EPD screen. This would allow the interaction with sensors to be “reactive” and hence power efficient instead of gestures initiating interaction with the device (the latter requires the device to be regularly looking for gesture input, draining power).
Sensors would be deployed to sense which screen the user is interacting with. It is important to determine which screen the user is interacting with since there could be two options (one associated with the EPD, the other with the main screen) that the user might be selecting and the device needs to be able to discriminate between them.
The device has pressure sensors on two opposing sides detecting pressure from the user.
   2. EPD Screen Display a Separate Application from the Main Screen's Application
The EPD screen is shown as a home screen pane and runs in the Android system as a separate activity or service (i.e. ‘application’).
The device would be seen as a one screen device from an Android compatibility sense.
The EPD screen would only be allowed to communicate with specified applications.
Only specified applications would be allowed to communicate with the EPD screen.

### 3. Combined Refresh of Widgets to Save Power

Widgets displayed on the EPD screen could have different update frequencies to reflect the type of widget.
For example
   Weather widget updates every 30 minutes
   Clock widget updates every 1 minute
   Twitter widget updates on demand
   Friends nearby widget updates every 5 minutes
Combining each update to a specific time, where as many widgets are updated at the same time as possible saves energy. This could for instance be used to combine the updates in full minutes—e.g. all widgets only ever update once every 5 minutes.
New events received between updates would not be displayed until the update time (e.g. once every 5 minutes). Neither would the widgets poll this information.
In an alternative arrangement the information would be pushed to the device and displayed on the EPD screen as soon as they arrived. This would significantly alter the battery performance.
It is understood that full refreshes of the EPD screen sometimes would be necessary to clear out artifacts and shadows possibly occurring when only partially updating the screen.

### 4. The Back Screen is a “Virtual Home Screen”

The bistable display (EPD) on the device's rear side is accessed for setup (see section 7 below) and adjustments through a virtual home screen via the main display on the main display of the device.
The EPD pane is located at for example position 0 in relation to the other home screens on the device.
The EPD pane can be accessed through swiping through the other screens to position 0.
The EPD pane can also be directly accessed via a screen wide two finger swipe. Swiping one direction will bring up the EPD pane and swiping the other direction will take the user back to the previous home screen pane.

### 5. Shortcut Navigation Between Home Screen Panes

On each home screen pane a shortcut icon is found. When the user touches the icon it is expanded with a shortcut for each home screen pane. When moving the finger over the icons a home screen preview is shown. Releasing the finger on an icon will bring the corresponding home screen pane to be shown in the display.
   6. EPD Display Appearance when Interacting with Main Screen
The EPD display will show wallpaper only when the user is interacting with the main front display. The wallpaper, i.e. image used as a background, may be Android ‘live wallpaper’. See also section 12 below.

### 7. The EPD Configuration Screen

The EPD configuration screen, which is shown on the main display, includes a replica of the actual EPD with the top part removed. The top part is removed to give the user a less downscaled mirror of the EPD.
The user cannot place widgets on the top part of the EPD screen.
When the user enters this configuration screen it is optional to have the top part of the options menu shown. When displayed it contains the EPD widgets on/off switch. When the user taps elsewhere on the screen the menu is folded.
When touching the menu a lower pane is revealed with options for “add widget”, “EPD wallpaper” and “EPD settings”.

### 8. On/Off Switch for Widgets

The user can select to turn on or off all widgets on the EPD back screen by touching the on/off switch on the configuration screen.
Instead of having more panes, settings and/or profiles there are simply two modes: to not show or to show widgets on the back screen.
If the widgets are turned off, they will be shown faded on the EPD configuration screen. When turned off they will not be visible on the EPD back screen.
Controlling the widgets on/off switch can also be done through other parts of the VI. For instance, the widgets could be turned off when turning on “silent mode” on the phone. There could also be a setting to turn on/off the widgets.

### 9. Layout of the EPD Screen

The alarm clock indicator is shown if the user has set an alarm. The user cannot control the alarm clock indicator.
The critical battery level indicator is only displayed if the battery has reached a predefined level. The user cannot control the critical battery level indicator.
The EPD display is divided into a 4×8 grid where the widgets can be placed.
Widgets can have the size of: 1×1, 1×2, 1×4, 2×2, 2×4, 3×4 or 4×4 of the grid's squares.

### 10. Adding and Editing Widgets on the EPD Screen

The user can long press the background on the EPD configuration screen or alternatively select “add widget” from the menu.
The user is then taken to a widget-editing menu. The menu can be expanded or collapsed and the user can switch between these modes by touching an icon. The alternative is to have the menu items always expanded or always collapsed, until the user selects a menu item.
When a menu item is tapped it is expanded, if not already expanded, and a first available layout alternative for the widget is displayed. The user can swipe left or right or tap the directional arrows to see further available layout alternatives for the widget.
If the header is pressed on the expanded item, the item is folded.
To select a widget and place it on the EPD screen the user taps it.
If a user taps another item in the menu list, the currently expanded item is closed and the new item is expanded.
If, when the user selects to add a widget, there is not enough space on the EPD screen, the user is taken to a different screen. The layout preview is faded and the amount of missing space is marked with a different color.
   The user is presented with a dialog to inform the user that there is not enough space.
   The user is further presented with a shortcut to go to the edit screen where he can free up the needed space by either changing the layout of another widget or removing it.
   An alternative layout of the notification screen of lacking space is to do the clearing up of screen space automatically or to present the option to free up space already in the add widget mode.
When the user has selected a widget he is presented with a grid representing the space on the EPD screen. The user can move the widget around and place it.
The user can also in this editing mode change the layout of the widget by tapping the arrows on the sides of the screen.
When the user is not dragging an object, a done button appears at the bottom of the screen.
If there already are widgets placed on the EPD screen they are shown faded, to indicate that that space is occupied. The user is able to move that other widget around and change its layout. The user selects that widget by tapping on it.
Tapping an empty grid takes the user to the add widget screen and he can from there add another widget. The Done button to be shown on the screen is therefore optional.
When an already selected widget is tapped in edit mode, the settings for that widget is opened. One option is to have a settings icon on top of the widget to communicate that the settings menu is accessible.
All settings are saved as soon as the user makes them and pressing the Android back-key (hardware or software) takes the user back to the widget layout editing screen.

### 11. EPD Screen Widget Layout and Privacy

The widgets shown on the EPD screen have different layouts. These layouts can be related to the privacy level that the user decides to use for the information shown on the back screen.
The different layout modes selectable by the user can contain a variable amount of information or display the same information in different ways but for instance use different size of the screen.
There are different levels of privacy for the information shown.
   EPD widget mode. Private information will be displayed with details. For instance full name is shown on caller and missed calls. Name of sender and part of message can be shown for a new message (SMS, MMS, Facebook Twitter etc.) or email. Wallpaper can be shown in the background.
   Peek view. A private mode where only the number of missed calls and unread messages are shown. The names and content of the messages and calls are not shown. Generic information such as the clock could also be shown. This mode is not customizable by the user.
   Wallpaper only. A further mode provides that no information except the wallpaper is shown.
When the user activates the key lock, he is prompted with the option to turn off the EPD widget mode. This can also be done through other parts of the UI.

### 12. EPD Screen Wallpaper

To set the wallpaper background on the EPD screen the user selects the “EPD wallpaper” icon on the EPD pane which is accessible from the home screen. If the menu is hidden the user can press the menu key.
When the “EPD wallpaper” icon has been selected the user is taken to a screen where he is presented with three options; New photo, EPD Wallpapers and Gallery.
   Selecting New photo takes the user to the camera application for taking and adjusting and cropping the new photo and then select as wallpaper.
   Selecting EPD Wallpapers takes the user to the EPD Wallpaper gallery to select a wallpaper.
   Selecting Gallery takes the user to the native gallery application where the user can select, crop and adjust an image.
The wallpaper could also be set from other parts of the UI when selecting the wallpaper item in the options menu. The user is then presented with a dialog asking which wallpaper he would like to set (home screen/lock screen/EPD).
Depending on the selected wallpaper, the EPD screen could sometimes need to adjust the brightness of the text and widgets on the screen for best view.

### 13. EPD Screen Wallpaper Photo as Texture

The EPD wallpaper could also be constructed of the pattern as captured by the device's camera.
The pattern of the photo would then be duplicated to the wallpaper as a pattern and not as a photo.
   14. Interaction with the EPD Screen
When the user is interacting with the main screen, the EPD screen is only showing the wallpaper. No private information is shown.
   Some specific applications could override this main setting. Examples could be, if the user uses the camera an image of a camera could be displayed on the EPD screen or other applications such as in-call or music player.
The EPD screen can be activated and the front screen deactivated by the user.
   If the device is turned around and placed on a flat surface (e.g. table) the front screen (facing the table top and hence not visible) is turned off and the EPD screen is activated.
   If the user squeezes the sides/side buttons on the device, the front screen is turned off and the EPD screen is activated.
   If a timeout limit is reached (e.g. 1 minute) the front screen is turned off and the EPD screen is activated.
   More generally, rotation of the device can be used as the control input—e.g. to initiate some action or process, like answering a call (see section 17 below) or to control in some manner the EPD or the main screen.

### 15. EPD Privacy Setting Interaction

The user can switch between the different privacy modes/display of available information on the EPD screen by double tapping the device or EPD.
If the user has enabled the widget mode in the EPD settings screen the double tapping will alter the EPD screen between the modes Wallpaper only/Peek view/EPD widget mode in a predefined direction.
If the user has enabled the widget mode in the EPD settings screen the double tapping will alter the EPD screen between the modes Wallpaper only/Peek view.
   16. EPD Interaction with Notifications
If the user has activated the EPD screen and a new event occurs (message: E-mail, SMS/MMS, Facebook) the user is presented with a notification.
The notification is displayed for a predefined time. The screen then returns to the previous state.
While on the screen, the notification takes over the EPD screen real-estate.
If the user taps the device twice when the notification is shown the message is expanded and shown on the EPD screen. Longer messages will be abbreviated.
   If the user has activated a PIN code for this action the tapping does not expand the notification. The user is then notified that he needs to turn the device and enter the code to see the message on the main screen.
When the user has expanded the notification to show the message on the EPD screen he can turn the device around to see the message on the main screen. The user is then taken to the right place in the UI to see the message or event. The user is also able to instantly interact with the message or event (e.g. respond, accept/decline). This turning/flipping action also unlocks the main screen if it has been locked.
The user can also dismiss a notification being shown on the EPD screen and return the screen to the previous state.
   The user can grab the phone and lift it up and gently return it to its previous position. This will dismiss the notification.
   The user can also grab the phone and lift up one side of the device and let it go to return to its previous position. This will dismiss the notification.
The user can as an alternative also show and expand the last shown notification when the notification is no longer shown by tapping the device three times. The message or event is then shown on the EPD screen.
The user can then interact with the notification as above, turning the device to interact on the main screen.
   17. EPD Interaction when Call is Received
If the user has activated the EPD screen and an incoming voice call (phone, Skype or other voice service) is received the event takes over the entire EPD screen real estate.
The front screen is turned on at the same time as the EPD screen event is shown. No other interaction then in relation to the call is allowed.
Interaction (touch) with the front screen is not supported until the device has been turned around and the front screen is facing up.
When the user has turned the device around he can interact with the front screen. The same interaction is possible irrespective if the screen was locked or unlocked before the call.
The user is presented with a screen where the user can swipe to answer the call. The user swipes up to decline the call and down to answer the call.
If the user presses the Menu button (HW or SW) the user is presented with the options “mute”, “decline” and “send SMS”.
   The options Decline and send SMS would require the user to enter the PIN code if the device has that option enabled before being able to proceed.
If the user declines the call he is presented with an overlay of the screen for a predefined time. The user can select to send a message to the declined caller, Tapping on the non-overlaid part of the screen will dismiss the overlay.
The user can also mute the call when the notification is shown on the EPD screen.
   The user can grab the phone and lift it up and gently return it to its previous position. This call is muted.
   The user can also grab the phone and lift up one side of the device and let it go to return to its previous position. This call is muted.

### 18. Full EPD Screen Usage

Some applications or events on the device will overtake the EPD screen and do a full graphics overlay.
   When a call is received and when the user is in an active voice call the EPD screen shows a phone symbol. No other information is being shown on the EPD screen.
   When the user activates the camera application on the device the EPD screen displays a camera skin. The user can select the desired camera skin to be displayed.
   When the user uses the media player on the device a music-related skin is displayed on the EPD screen. This skin is user selectable or could be automated depending on the media played.
   When the device power level is low.

### 19. Living/Live Wallpaper

The wallpaper of the EPD screen could in one mode change itself depending on the surrounding factors and other activating events.
Activating events could be
   Location
   Time
   Upcoming events in calendar
   Weather (+location)
The refresh rate should be low (eg. once per day), so as not to annoy the user with new information too often or unnecessarily drain the battery.
The wallpaper can change very slowly so that eg. the change is only really noticeable after an hour, or after a few hours.

### APPENDIX 1

### Primer on LTE

3GPP Long Term Evolution, usually referred to as LTE, is a standard for wireless communication of high-speed data for mobile phones and data terminals. It is based on the GSM/EDGE and UMTS/HSPA network technologies, increasing the capacity and speed using new modulation techniques. The standard is developed by the 3GPP (3rd Generation Partnership Project).

The world's first publicly available LTE service was launched by TeliaSonera in the Scandinavian capitals Stockholm and Oslo on 14 Dec. 2009. LTE is the natural upgrade path for carriers with GSM/UMTS networks, but even CDMA holdouts such as Verizon in North America and KDDI in Japan have announced that they will migrate to LTE in the future. LTE is therefore anticipated to become the first truly global mobile phone standard.

Although commonly referred to as a type of 4G wireless service, LTE release 8 currently in use does not satisfy the requirements set forth by the ITU-R organization. Future releases of LTE (referred to as LTE Advanced) are expected to satisfy the requirements to be considered 4G.

LTE is a standard for wireless data communications technology and an evolution of the GSM/UMTS standards. The goal of LTE is to increase the capacity and speed of wireless data networks using new DSP (Digital Signal Processing) techniques and modulations that were developed in the beginning of the new millennium. Its wireless interface is incompatible with 2G and 3G networks, and so it must be operated on a separate wireless spectrum.

LTE was first proposed by NTT DoCoMo of Japan in 2004. The standard was finalized in December 2008, and the first publicly available LTE service was launched by TeliaSonera in the Scandinavian capitals Stockholm and Oslo on Dec. 14, 2009 as a data connection with a USB modem. In 2011, LTE services were launched by major North American carriers as well, with the Samsung Galaxy Indulge offered by MetroPCS starting on Feb. 10, 2011 being the first commercially available LTE phone and HTC ThunderBolt offered by Verizon starting on March 17 being the second LTE phone to be sold commercially. Initially, CDMA operators planned to upgrade to a rival standard called the UMB, but all the major CDMA operators (such as Verizon, Sprint and MetroPCS in the United States, Bell and Telus in Canada, au by KDDI in Japan, SK Telecom in South Korea and China Telecom/China Unicom in China) have announced that they intend to migrate to LTE after all. The evolution of LTE is LTE Advanced, which was standardized in March 2011. Services are expected to commence in 2013.

The LTE specification provides down-link peak rates of 300 Mbit/s, uplink peak rates of 75 Mbit/s and QoS provisions permitting round-trip times of less than 10 ms. LTE has the ability to manage fast-moving mobiles, and support for multi-cast and broadcast streams. LTE supports scalable carrier bandwidths, from 1.4 MHz to 20 MHz and supports both frequency division duplexing (FDD) and time-division duplexing (TDD). The architecture of the network is simplified to a flat IP-based network architecture called the Evolved Packet Core (EPC), designed to replace the GPRS Core Network and support seamless handovers for both voice and data to cell towers with older network technology such as GSM, UMTS and CDMA2000. The simpler architecture results in lower operating costs (for example, each E-UTRAN cell will support up to four times the data and voice capacity when compared to HSPA).

### APPENDIX 2

### Primer on LTE Advanced

LTE Advanced is a preliminary mobile communication standard, formally submitted as a candidate 4G system to ITU-T in late 2009, was approved into ITU, International Telecommunications Union, IMT-Advanced and expected to be finalized by 3GPP in early 2011. It is standardized by the 3rd Generation Partnership Project (3GPP) as a major enhancement of the 3GPP Long Term Evolution (LTE) standard.

The LTE format was first proposed by NTT DoCoMo of Japan and has been adopted as the international standards. LTE standardization has come to a mature state by now where changes in the specification are limited to corrections and bug fixes. The first commercial services were launched in Scandinavia in December 2009 followed by the United States and Japan in 2010. More first release LTE networks are expected to be deployed globally during 2010 as a natural evolution of several 2G and 3G systems, including Global system for mobile communications (GSM) and Universal Mobile Telecommunications System (UMTS) (3GPP as well as 3GPP2).

Being described as a 3.9G (beyond 3G but pre-4G) technology the first release LTE does not meet the IMT Advanced requirements for 4G also called IMT Advanced as defined by the International Telecommunication Union such as peak data rates up to 1 Gbit/s. The ITU has invited the submission of candidate Radio Interface Technologies (RITs) following their requirements as mentioned in a circular letter. The work by 3GPP to define a 4G candidate radio interface technology started in Release 9 with the study phase for LTE-Advanced. The requirements for LTE-Advanced are defined in 3GPP Technical Report (TR) 36.913, “Requirements for Further Advancements for E-UTRA (LTE-Advanced).” These requirements are based on the ITU requirements for 4G and on 3GPP operators' own requirements for advancing LTE. Major technical considerations include the following:
Continual improvement to the LTE radio technology and architecture
Scenarios and performance requirements for interworking with legacy radio access technologies
Backward compatibility of LTE-Advanced with LTE. An LTE terminal should be able to work in an LTE-Advanced network and vice versa. Any exceptions will be considered by 3GPP.
Account taken of recent World Radiocommunication Conference (WRC-07) decisions regarding new IMT spectrum as well as existing frequency bands to ensure that LTE-Advanced geographically accommodates available spectrum for channel allocations above 20 MHz. Also, requirements must recognize those parts of the world in which wideband channels are not available.

Likewise, 802.16m, ‘WiMAX 2’, has been approved by ITU into the IMT Advanced family. WiMAX 2 is designed to be backward compatible with WiMAX 1/1.5 devices. Most vendors now support ease of conversion of earlier ‘pre-4G’, pre-advanced versions and some support software defined upgrades of core base station equipment from 3G.

The mobile communication industry and standardization organizations have therefore started to work on 4G access technologies such as LTE Advanced. At a workshop in April 2008 in China 3GPP agreed the plans for future work on Long Term Evolution (LTE). A first set of 3GPP requirements on LTE Advanced has been approved in June 2008. Besides the peak data rate 1 Gbit/s that fully supports the 4G requirements as defined by the ITU-R, it also targets faster switching between power states and improved performance at the cell edge. Detailed proposals are being studied within the working groups.

### APPENDIX 3

### Dirty Rectangles

Dirty Rectangles are used extensively in computer/video game programming for fast, flicker-free double-buffer graphic updating. The following will give you the gist of it:

Ideally, the bounding rectangles of the items on screen which need to be drawn are accumulated in a list. Intersecting rectangles are unioned, the union stored in the list, and the two original rectangles thrown away (other optimizations are possible.)

When it comes time to draw, we can use the list of dirty rectangles to limit what actually gets blitted (copied.) We blit the background thru the rectangles, and then draw whatever needs to get drawn—whatever intersects any dirty rectangle.

We save that list for the next pass because we will union that entire list with the new list of things to be drawn so that we erase everything properly. We also use that combined list to blit thru onto the screen. We then throw away the combined list, and save the most recent Dirty Rectangle list for the next pass.

Obviously, Dirty Rectangles are useful for any graphical system where many small objects change over time. This is true for game sprites as well as user interfaces. It is inefficient for, say, full-screen animation.

Saving the list of Dirty Rectangles between frames and doesn't work because you miss painting the old positions of sprites that had not moved last frame. It's better to record which rectangles need to be redrawn as objects move.

### APPENDIX 4

### Widgets

In computing, a widget is a component of a user interface that operates in a particular way.

Desktop widgets (commonly just called widgets) may be interactive virtual tools that provide single-purpose services such as showing the user the latest news, the current weather, the time, a calendar, a dictionary, a map program, a calculator, desktop notes, photo viewers, or even a language translator, among other things. Examples of widget engines include:
Dashboard widgets of Apple Macintosh
Microsoft gadgets in Windows Vista and in the Windows Live system
Plasmoids are widgets in Plasma, the workspace for the KDE desktop environment.
Portlets in Google Desktop
Yahoo! Widgets
gdesklets, adesklets, and Screenlets in Linux
Opera widgets on all platforms (desktop, mobile TVs, gaming consoles) using the Opera browser's rendering engine.
Homescreen widgets in Maemo

Originally, desk accessories were developed to provide a small degree of multitasking, but when real multitasking operating systems became available, these were replaced by normal applications.

Most mobile widgets are like desktop widgets, but for a mobile phone. Mobile widgets can maximize screen space use and may be especially useful in placing live data-rich applications on the device idle-screen/home-screen/“phone-top”. Several Java ME-based mobile widget engines exist, but the lack of standards-based APIs for Java to control the mobile device home-screen makes it harder for these engines to expose widgets on the phone-top.

1. Bar form factor mobile display device comprising front and back major faces, the front major face arranged to present a normal power first display screen and the back major face arranged to present a low power second display screen, wherein the device includes a computer.

2-6. (canceled)

7. Bar form factor mobile display device of claim 1, wherein the device includes sensors and wherein the device is operable to process input from the sensors when the first display screen is off.

8-13. (canceled)

14. Device of claim 1, wherein the first display screen is a touch screen.

15. (canceled)

16. Device of claim 1, wherein the second display screen is a touch screen.

17-19. (canceled)

20. Device of claim 1, wherein the first display screen output is generated by a first application and the second display screen output is generated by a second application different to the first application.

21. Device of claim 1, wherein the first display is operable to display a home screen pane corresponding to the second display screen.

22-23. (canceled)

24. Device of claim 1, wherein the second display is operable to display a plurality of widgets, wherein at least two of the widgets have different update frequencies.

25-29. (canceled)

30. Device of claim 21, wherein the second display is operable to be configured, and wherein the second display configuration is operable to be changed via the first display.

31. (canceled)

32. Device of claim 21, wherein the second display is operable to be configured, and wherein a device screen page for initiating the changing of the configuration of the second display is at the same level in the menu hierarchy as other home panes on the device,
or wherein the device screen page for initiating the changing of the second display configuration is accessible by swiping through other screens;
and wherein the device screen page for initiating the changing of the second display configuration is accessible by a screen wide two finger swipe,
and wherein a two finger swipe in a first direction brings up the screen page for initiating the changing of the second display configuration, and a two finger swipe in the opposite direction to the first direction brings up a previously displayed home page.

33-39. (canceled)

40. Device of claim 1, wherein the second display displays only wallpaper when a user is interacting with the first display.

41. (canceled)

42. Device of claim 30, wherein the second display configuration screen displayed on the first display includes a replica of the second display screen.

43-54. (canceled)

55. Device of claim 1, wherein the second screen displays an alarm clock indicator in response to an alarm clock having been set on the device, and the second screen is not configurable not to display the alarm clock indicator in response to an alarm clock having been set on the device.

56. Device of claim 1, wherein the second screen displays a critical battery indicator in response to the battery reaching a predefined level, and the second screen is not configurable not to display the critical battery indicator in response to the battery reaching a predefined level.

57. Device of claim 1, wherein the second display is operable to display a plurality of widgets, wherein the second display is divided into a grid comprising grid elements, wherein each widget is presented using grid elements.

58-62. (canceled)

63. Device of claim 30, wherein the second display configuration is operable to be changed via a second display configuration screen on the first display, and the configuration screen is operable to add or edit widgets for the second display.

64-112. (canceled)

113. Device of claim 1, wherein when a user is interacting with the first screen, the second screen displays only wallpaper.

114. (canceled)

115. Device of claim 1, wherein when a user is operating a device function, an image corresponding to that device function is shown on the second screen.

116-117. (canceled)

118. Device of claim 115, wherein when the device function is a music playing function, the second screen displays a music-related image.

119. Device of any previous 1, wherein the device is operable to provide a deactivated first screen and an activated second screen in response to a user manipulation of the device.

120-123. (canceled)

124. Device of claim 1, wherein the device is operable to provide a deactivated first screen and an activated second screen in response to a timeout limit of the device.

125. Device of claim 1, wherein the device is operable to answer a call in response to a user manipulation including a device rotation.

126-128. (canceled)

129. Device of claim 1, wherein the device provides a selectable option to provide notifications on the second screen.

130-136. (canceled)

137. Device of claim 129, wherein when a notification is displayed the device is operable to dismiss the notification and return the second screen to a previous state.

138-139. (canceled)

140. Device of claim 129, wherein when no notification is displayed on the second screen, the device is operable to display on the second screen the most recently displayed notification in response to three taps on the device.

141. (canceled)

142. Device of claim 1, wherein the device provides a selectable option to provide output on the second screen.

143. Device of claim 142, wherein an incoming voice call to the device is announced on the entire second screen.

144. (canceled)

145. Device of claim 142, wherein no interaction in relation to an incoming call is allowed until the device has been turned over from the second screen to the first screen.

146-157. (canceled)

158. Device of claim 1, wherein the device is operable to display a full graphics overlay on the second screen in response to an application running on the device, or to an event occurring at the device.

159-165. (canceled)

166. Device of claim 1, wherein the second screen is operable to display a wallpaper, and wherein an application which provides the wallpaper for display is operable to change the displayed wallpaper without user intervention.

167-191. (canceled)

192. Method of operating a device of claim 1, comprising the step of the device changing what is displayed on the device.

193. Computer program product operable when running on a device of claim 1 to enable the device to receive a user input to the device.

194. Computer program product operable when running on a device of claim 1 to change what is displayed on the device.
